(19) United States
(12) Patent Application Publication
(10) Pub. No.: US 2005/0096943 A1
(43) Pub. Date: May 5, 2005

(54) System and method for correlating market research data based on sales representative activity

(76) Inventors: Ilene L. Siegalovsky, Wayne, NJ (US); James R. Callandrillo, Rutherford, NJ (US)

Correspondence Address: JOHN M. JOHNSON;CARTER LEDYARD & MILBURN LLP, 2 WALL STREET, NEW YORK, NY, 10005, US

(21) Appl. No.: 10/701,751

(22) Filed: Nov. 5, 2003

(51) Int. Cl. G06F 17/60

(52) U.S. Cl. 705/2

(57) ABSTRACT

The invention relates to an integrated system and method for collecting information for the pharmaceutical industry to assess opinions concerning sales and marketing forces, prescribing patterns and attitudinal physician perceptions regarding specific pharmaceutical brands. These three areas are evaluated through three modules, each consisting of a separate survey administered via the internet, and capable of producing reports integrating all three areas. The surveys are entitled: 1) Continuous Promotion Tracking Study (CPT); 2) Rx Intentions and Treatment Study (RxIT); and 3) Therapeutic Class Attitude and Perception Study (TCAP).

### BACKGROUND OF THE INVENTION

This invention relates to a system and method for measuring: 1) the quantity and quality of physician encounters with promotional activities of various pharmaceutical companies, including pharmaceutical sales representatives and detailing information published by the companies; 2) physicians' actual prescription decisions concerning particular classes of patients, and both medical and nonmedical factors influencing those decisions (all measured from actual patient records); and 3) physicians' attitudes toward, and perceptions of, specific pharmaceutical brands, concerning particular classes of patients. More specifically, the invention relates to the application and processing of the data of 1), 2) and 3) above in order to provide pharmaceutical companies with correlations between physician and pharmaceutical sales representative pre-prescription activities, and physician pharmaceutical brand attitudes with the actual and future sales of the pharmaceuticals of both the pharmaceutical company and of its competitors.

The drawbacks of the prior art are best described by a series of “trade-offs,” which pharmaceutical companies must choose between to accomplish their research-related goals. First, many companies produce and market multiple pharmaceutical products. Research companies analyze the physicians' attitudes, prescription frequency and marketing influence (including sales representative performance) of each brand, with the goal of addressing/improving each area as needed. Companies have unique brand needs they wish to understand, and employees at the director level or above are typically responsible for more than one brand. These directors report to upper-level management about those brands. Brand tracking, however, has been measured with different metrics, which produce different reporting formats, thus increasing the difficulty for companies to discern the results of the analysis for each of their brands in a timely fashion. Companies desire more consistent metrics across studies over time to eliminate the need for reeducating senior management about how metrics are defined and what they illustrate. That is, companies require templated surveys. Simultaneously, companies require studies that evaluate attributes specific to each drug class.

Second, companies require research to be performed in multiple areas, such as message recall studies (i.e., what message from pharmaceutical sales representatives and/or marketing literature are effective with physicians) or brand tracking (e.g., measuring customer satisfaction, performance, etc.). Companies may require the services of multiple vendors who each specialize in a particular area of research. Coordinating work with those vendors and integrating the research of all vendors, all of whom may use different sampling methodology and sources, is timely and costly. For example, a full cause-and-effect analysis based on all of the factors relevant to prescribing cannot be performed where pieces of data are not collected from the same physicians, and where varying samples and methodology otherwise vary.

Third, management personnel who review whatever research reports have been commissioned do not have a great deal of time, and often require only a simple, concise summary of the reports for their immediate needs (i.e., in preparation for a brief meeting). At the same time, however, those same personnel may ultimately need to hone in on specific facets of the report and may require a more detailed analysis with respect to those factors. In that case, the concise report, while convenient earlier, now will not provide the necessary depth to engage in a sophisticated analysis, and to ultimately develop an effective plan of action. Moreover, in most cases, companies have spent significant sums of money for extensive research.

Fourth, companies benefit best by maximizing the frequency and timeliness of tracking their brands, whether by number of prescriptions written, the effect of a new competitor or otherwise. These goals, however, often mean assembling a sample panel to provide the data, and increased costs based on the desired frequency. Additionally, results are not always timely enough to enable companies to respond quickly to the research results. In short, the prior art does not effectively address the needs of companies for inexpensive, thorough, comprehensible, integrated and timely research.

### SUMMARY OF THE INVENTION

The invention relates to an integrated system and method for collecting information for the pharmaceutical industry to assess opinions concerning sales and marketing forces, prescribing patterns and attitudinal physician perceptions regarding specific pharmaceutical brands. These three areas are evaluated through three modules, each consisting of a separate survey administered via the internet, and capable of producing reports integrating all three areas. The surveys are entitled: 1) Continuous Promotion Tracking Study (CPT); 2) Rx Intentions and Treatment Study (RxIT); and 3) Therapeutic Class Attitude and Perception Study (TCAP).

An overall panel of physicians is established, and the panel is divided into thirds. Each physician on the overall panel is considered active on every third month. During any given data collection period, one-third of the overall panel is active. Each active panel physician is asked a series of questions from all of the three surveys. The physicians complete the survey on-line, and the data is compiled to determine, inter alia, marketing/sales force performance, prescribing patterns and physician pharmaceutical brand attitudinal perceptions for specific brands of pharmaceuticals.

In accordance with one exemplary aspect of this invention, the data from all three surveys is analyzed regarding the opinions concerning marketing/sales forces, prescribing patterns and attitudes for each brand. The reports are capable of integrating multiple areas of research gathered from all three surveys, and are produced in a timely (˜15 days after completion of surveys), automated manner. Consistent templates are used to display the reports for multiple categories affecting perception and prescribing of certain brands. Reports take the form of concise, snapshot “funnel” displays, but also take the form of more in depth (“drill down”) analyses of the data. The invention thus serves the immediate needs of a director to examine the results and report them to senior management, but to later view a more in-depth analysis.

In accordance with another exemplary aspect of this invention, the answers to these questions are coded into certain categories and generated into on-line reports to be accessed by each subscribing pharmaceutical company. These on-line reports are displayed both individually for each brand, and collectively for multiple brands, allowing the company to evaluate how its brands compare to other similar brands in the market. The on-line reports also contain illustrations of trends, both individualized and comparative.

In accordance with another exemplary aspect of this invention, reports are also compiled, which indicate, for example, why one specific drug was prescribed over another drug. In this respect, the impact of nonmedical factors, such as cost or managed care organization issues, on prescribing a particular brand may be manifested in the report results.

### BRIEF DESCRIPTION OF THE DRAWINGS

These and other subjects, features and advantages of the present invention will become more apparent in light of the following detailed description of a best mode embodiment thereof, as illustrated in the accompanying Drawings.

FIG. 1 is a block diagram of a data warehouse system constructed in accordance with one exemplary embodiment of this invention for carrying out one exemplary method of this invention;

FIG. 2 is a block diagram showing more details of the data reformatting utility of the data warehouse system shown in FIG. 1 in accordance with one exemplary embodiment of this invention for carrying out one exemplary method of this invention;

FIG. 3 is a block diagram showing more details of the MDD file reformatting utility of the data warehouse system shown in FIG. 1 in accordance with one exemplary embodiment of this invention for carrying out one exemplary method of this invention;

FIG. 4 is a flowchart showing a continuation from the data warehouse system illustrated in FIG. 1 showing further processing and organization of data in accordance with one exemplary embodiment of this invention for carrying out one exemplary method of this invention;

FIG. 5 is a block diagram of the computer hardware in accordance with one exemplary embodiment of this invention for carrying out one exemplary method of this invention;

FIG. 6 is a block diagram illustrating the composition of a sample panel of respondents, whose completion of survey questions constitutes the research data, which will be processed in the manner described in FIGS. 1-5 in accordance with one exemplary embodiment of this invention for carrying out one exemplary method of this invention;

FIG. 7 is a block diagram showing a high-level overview from assembling the panel of respondents, to producing the output/reports, in accordance with one exemplary embodiment of this invention for carrying out one exemplary method of this invention;

FIG. 8 is a block diagram showing the fundamental research dimensions which the survey questions are intended to examine in accordance with one exemplary embodiment of this invention for carrying out one exemplary method of this invention;

FIG. 9 is a block diagram showing “drill downs” (i.e., factors which may affect a brand's ratings in the research dimension categories described in FIG. 8) in accordance with one exemplary embodiment of this invention for carrying out one exemplary method of this invention;

FIGS. 10-14 are report screens showing the profiles of various brands in terms of the brands' “funnel” profiles (as described in FIG. 8) in accordance with one exemplary embodiment of this invention for carrying out one exemplary method of this invention;

FIGS. 15-18 are sample report screens of slide-based output reports, showing the “drill down” effects, listed in FIG. 9, on several of the fundamental research dimensions listed in FIG. 8 in accordance with one exemplary embodiment of this invention for carrying out one exemplary method of this invention;

FIG. 19 is a report screen showing a combination of reports in a set of competitive brands, in a bar/line graph (illustrating trends) and in “funnel” format in accordance with one exemplary embodiment of this invention for carrying out one exemplary method of this invention;

FIG. 20 is a block diagram showing “drill down” diagnostics for the specific research area of Brand Loyalty and Switching in accordance with one exemplary embodiment of this invention for carrying out one exemplary method of this invention;

FIG. 21-24 are report screens showing analyses of the Brand Loyalty and Switching and Share Composition in vertical/horizontal bar and line graph formats in accordance with one exemplary embodiment of this invention for carrying out one exemplary method of this invention;

FIG. 25 is a block diagram showing “drill down” diagnostics for the Detail Metrics Report Card in accordance with one exemplary embodiment of this invention for carrying out one exemplary method of this invention;

FIG. 26 is a report screen showing a Detail Metrics Report Card for multiple brands in a competitive set, incorporating the “drill down” diagnostics of FIG. 25 in accordance with one exemplary embodiment of this invention for carrying out one exemplary method of this invention;

FIG. 26A is a block diagram containing definitions for the primary terms used in the Detail Metrics Report Card in FIG. 26 in accordance with one exemplary embodiment of this invention for carrying out one exemplary method of this invention;

FIGS. 27 and 28 are report screens showing analyses of detail metrics by individual categories, in both bar graph and line graph formats in accordance with one exemplary embodiment of this invention for carrying out one exemplary method of this invention;

FIG. 29 is a listing of data elements used in connection with the CPT survey in accordance with one exemplary embodiment of this invention for carrying out one exemplary method of this invention;

FIG. 30 is a partial survey template used in connection with the CPT survey in accordance with one exemplary embodiment of this invention for carrying out one exemplary method of this invention;

FIG. 31 is a listing of data elements used in connection with the RxIT survey in accordance with one exemplary embodiment of this invention for carrying out one exemplary method of this invention;

FIG. 32 is a partial survey template used in connection with the RxIT survey in accordance with one exemplary embodiment of this invention for carrying out one exemplary method of this invention;

FIG. 33 is a listing of data elements used in connection with the TCAP survey in accordance with one exemplary embodiment of this invention for carrying out one exemplary method of this invention;

FIG. 34 is a partial survey template used in connection with the TCAP survey in accordance with one exemplary embodiment of this invention for carrying out one exemplary method of this invention;

FIG. 35 is a block diagram of an on-line system structure in accordance with one exemplary embodiment of this invention for carrying out one exemplary method of this invention;

FIG. 36 is a report screen showing a screenshot of the web-based system companies use to access the reports in accordance with one exemplary embodiment of this invention for carrying out one exemplary method of this invention;

FIG. 37 contains two report screens showing trend analyses of occurrences during physician-patient interactions which resulted in new prescriptions or refills for previous prescriptive medication in accordance with one exemplary embodiment of this invention for carrying out one exemplary method of this invention;

FIG. 38 is a report screen showing a competitive set of brand “funnels,” and highlighting areas of significant changes with respect to each category in accordance with one exemplary embodiment of this invention for carrying out one exemplary method of this invention;

FIG. 39 is a report screen showing a “drill down” diagnostic analysis with respect to one of the six fundamental categories used to measure a brand's stance in the market in accordance with one exemplary embodiment of this invention for carrying out one exemplary method of this invention;

FIG. 40 is a report screen showing a cross-sectional analysis with respect to two of the six fundamental categories used to measure a brand's stance in the market in accordance with one exemplary embodiment of this invention for carrying out one exemplary method of this invention;

FIG. 41 is a report screen showing a “drill down” diagnostic analysis with respect to one of the six fundamental categories used to measure a brand's stance in the market in accordance with one exemplary embodiment of this invention for carrying out one exemplary method of this invention;

FIG. 42 is a report screen showing a cross-sectional analysis with respect to two of the six fundamental categories used to measure a brand's stance in the market in accordance with one exemplary embodiment of this invention for carrying out one exemplary method of this invention; and

FIGS. 43-44 are report screens showing “drill down” diagnostic and cross-sectional analyses with respect to two of the six fundamental categories used to measure a brand's stance in the market, focusing on the correlative relationship between those categories and one of their respective “drill downs,” in accordance with one exemplary embodiment of this invention for carrying out one exemplary method of this invention;

### DETAILED DESCRIPTION OF THE PREFERRED EMBODIMENTS

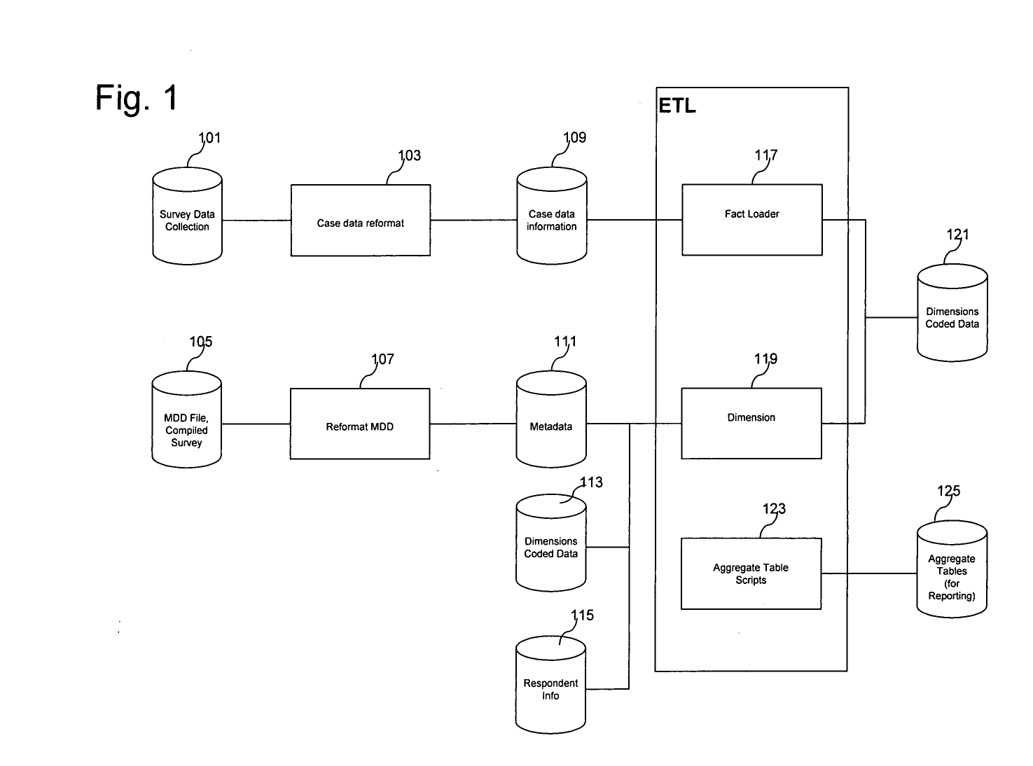

FIGS. 1-4 illustrate the data management system of the subject invention, which translates all of the survey data collected, loads it into the data warehouse and prepares it for reporting. The central core of all of data is loaded in a manner that can be easily used for data-mining or discerning patterns in the data. In FIG. 1, survey data collection 101 illustrates the gathering of data from the survey data collection utilities by way of on-line surveys, the contents of which are discussed in more detail infra. The survey data collection is preferably accomplished by on-line reporting from physicians as described more fully below. Each selected physician provides all of the survey data via a personal computer (or other Internet connectable electronic device) using standard Internet communication protocols known in the art such that the entered data is accessible by the data warehouse of FIGS. 1-4 herein, through the Internet connection of the data warehouse. Each survey is first recorded in a linear relational model format. At case data reformat 103, the data from the data collection survey is inputted and reformatted from a linear, horizontal-like format, to a more useful vertical format for the case data information 109. Data is stored in a response-oriented fashion within the data warehouse to allow easy preparation for multiple applications. A compiled survey MDD file 105, is fed into the MDD reformatting utility 107, which then produces the metadata 111 to be loaded into the data warehouse. Coded dimensional data 113 (i.e., product information, patient type, the therapeutic classes, the attributes, messages, all of which are topics explored in the surveys), is incorporated into metadata. Respondent information 115, such as the identity of the individual respondent and his/her medical specialty is also shown. All of the metadata 111, dimensions coded data 113 and respondent data 115 leads into an “ETL (‘Extraction Translation Loading’) loader” 119, which is a data warehouse industry term—i.e., a script to load all of the dimensions to the individual information. The fact loader 117 gathers information from the case data information 109 and loads the “fact table”—i.e., the fact information—from the data warehouse. The fact loader 117 and ETL loader 119 lead into the coded data warehouse 121. The coded data warehouse 121 contains all of the merged data, all of the dimensions (which describe facts in categorical form) and all of the facts. This data is then fed into another ETL tool, the aggregate table scripts 123, which filters out the types of questions to be used for reporting into the aggregate tables 125. The aggregate tables 125, in turn, are used for reporting. The types and formats of reports ultimately generated are exemplified later in this description.

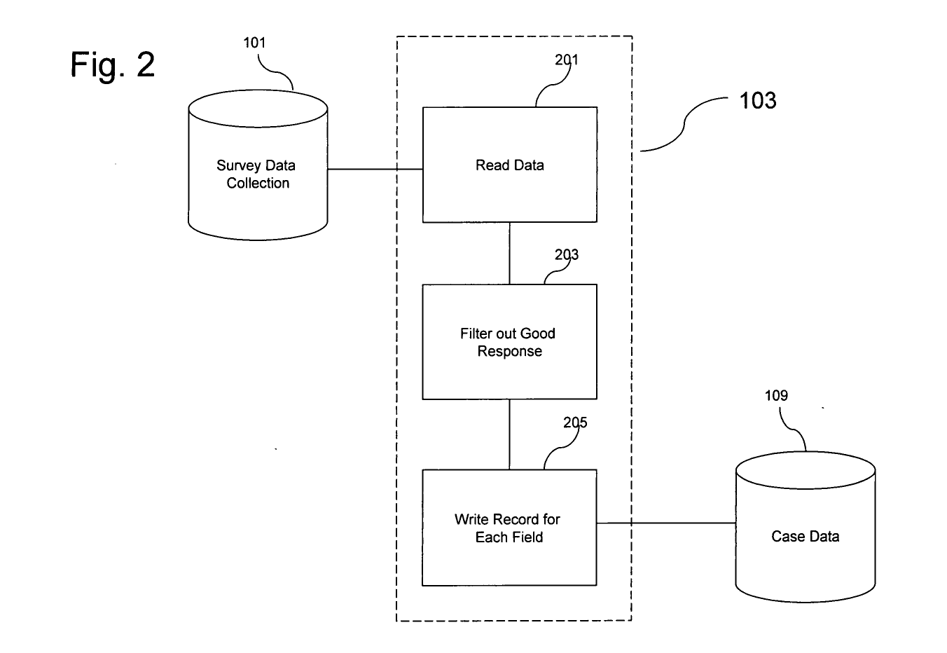

FIG. 2 describes in more detail the case data reformatting utility 103 in FIG. 1. The case data reformatting utility 103 takes the input from the data collection survey data 101, reads that data 201, and feeds it into a filter 203. The filter 203 determines what are valid and invalid responses, and then produces individual records 205 for every field from the survey data collection 101. The individual records are fed into the case data information 109.

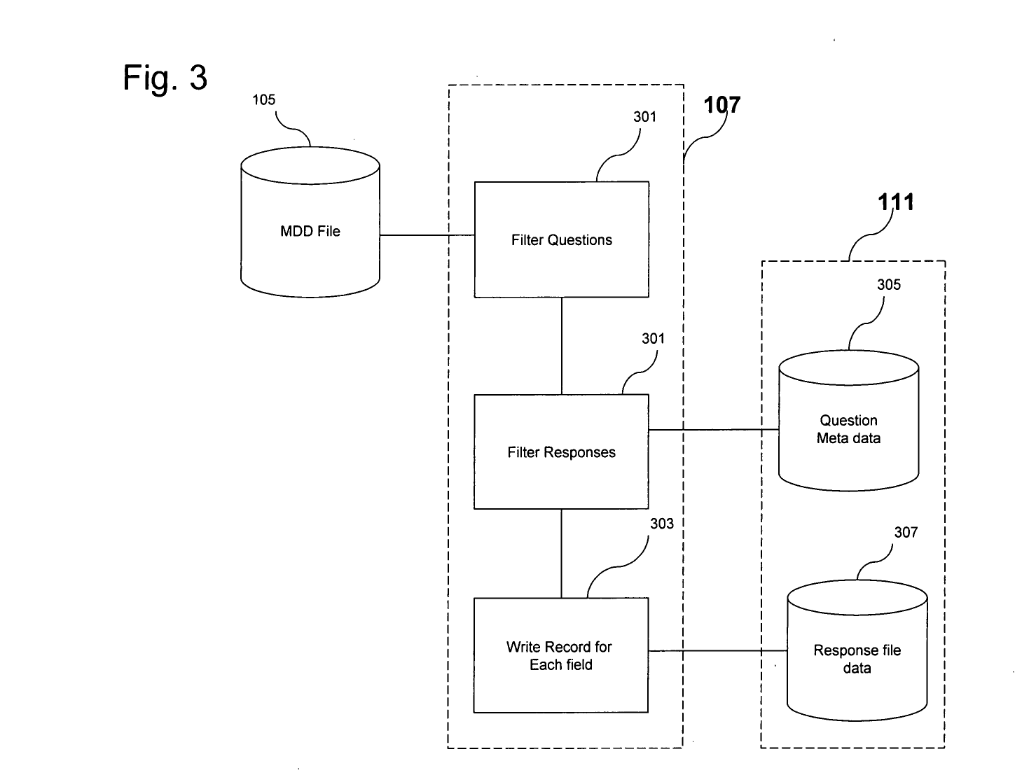

FIG. 3 describes in more detail the MDD file reformatting utility 107, which is the compiled survey file from the survey data collection software. The MDD file reformatting utility 107 divides questions from actual individual responses and writes them out. The MDD file 105 is fed into a filter 301 that filters all of the questions and writes out a question metadata file 305. After the questions from that MDD file have been filtered, records are written for each field with respect to that same MDD file 303 based on individual responses to each question, and a response file is written 307. The metadata file 305 and response file 307 together comprise the metadata 111 in FIG. 1.

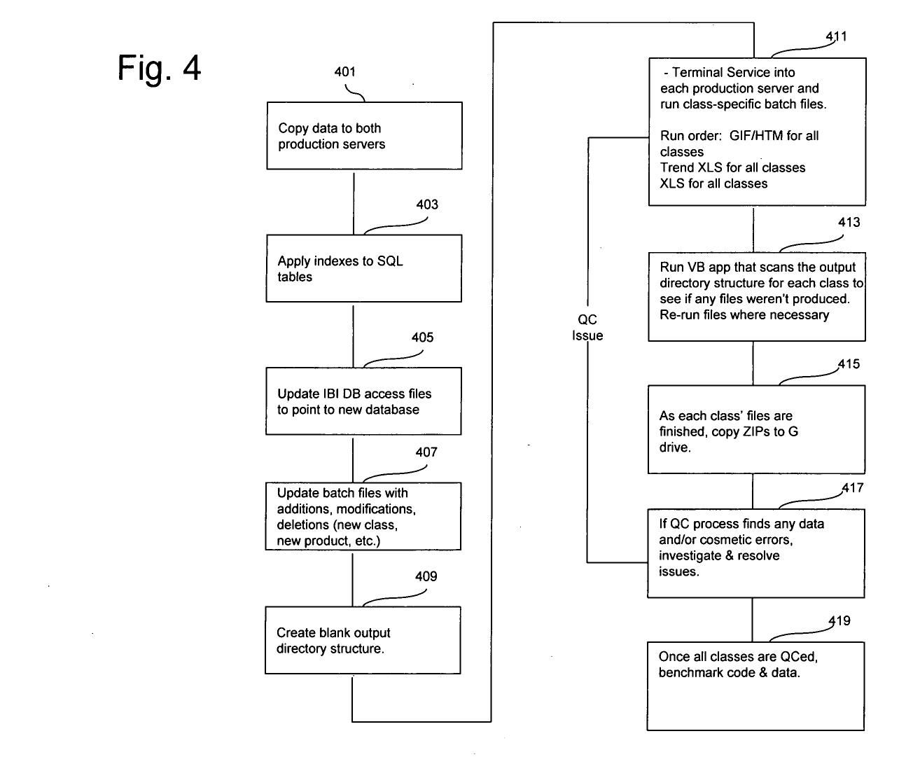

The process illustrated in FIG. 4 is a continuation of the process illustrated in FIG. 1, starting at aggregate tables 125. The data is copied to two production database servers 401. The reporting database changes each month and is based on the date on which the data is copied. This process enables the maintenance of a history of databases from previous months. Indexes are then applied to various tables and fields 403 to enhance the speed of generation.

Graphing software 405 known in the art (for example, IBI) is used to connect to the databases. The system also contains a set of batch files 407, which are divided by class, and subsequently within each class by section, enabling the updating of all data within a class, one section or merely one or two files. Changes based on the pharmaceutical industry frequently occur (e.g., the addition or deletion of a new product) and usually require modifications to certain files. The system also contains batch files that generate a blank output directory structure 409, which is also segmented by class and section. Within each section are different output format files.

At 411, each of the reporting servers is accessed, and class-specific batch files are run. Output is created for all file types and all classes. The run order may be, for example, GIF and HTML files for all classes, followed by Trend XLS files for all classes and finally all remaining XLS files for all classes. Then a Visual Basic program known in the art scans the output directory structure and identifies which, if any, files are missing as a quality check process 413 (thus eliminating this unnecessary burden on the system administrators to check each file manually, particularly where the volume of files is enormous). A report is generated to identify the missing files, and files may be rerun when necessary. Output is copied to a network folder 415, where other system administrators will perform a quality control analysis and place the output into a test site for further review. Thus, the files may be reviewed directly from the network folder, or through the test site.

The functions represented in elements 411-417 are continuous processes, involving modification at various points. For example, the quality control team may find cosmetic-related problems, and the necessary changes may affect all of the classes 417. These changes will require one graph across all of the classes to be run. After all of the data has been examined by a quality control team, the code and the data are “benchmarked,” (i.e., archived) 419. At that point, the system takes a snapshot of both the code and the data as of the when all of the modifications are finished, and are saved to allow the system administrators to return later and examine the code. In sum, FIGS. 1-4 illustrate the data processing, which begins with one SQL server database, and results in numerous output files, such as GIF graph files, HTML graph files and XLS data files.

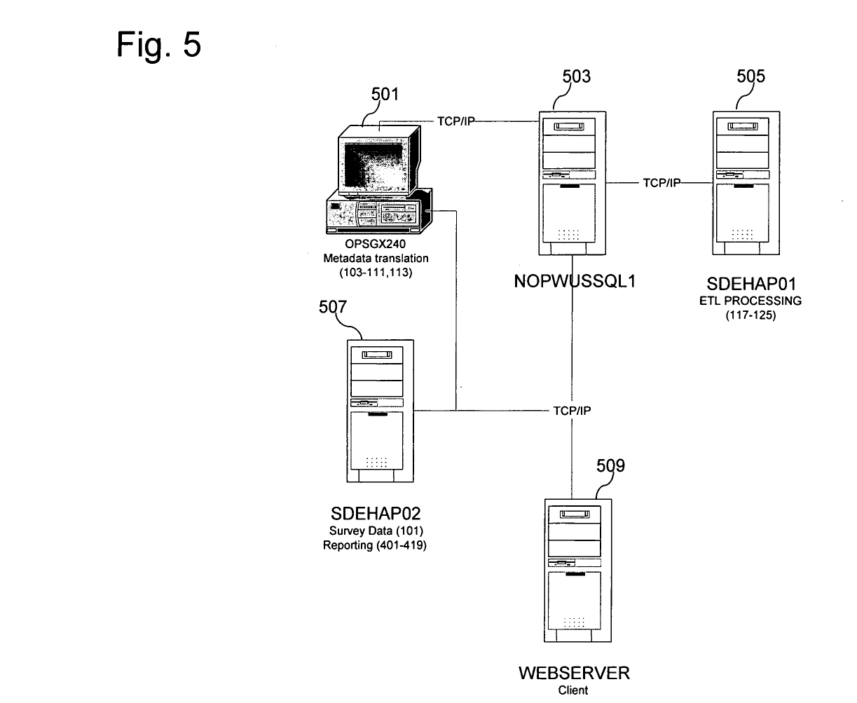

FIG. 5 shows the computer hardware used in connection with the data management system, described in FIGS. 1-4. All of the servers 501-509 shown in FIG. 5 are currently Dell brand servers known in the art, with the exception of the OPSGX240 server 501, which is a Dell brand desktop machine also known in the art. The servers 501-509 are connected using TCP/IP in a Windows 2000 environment. The OPSGX240 Windows 2000 workstation 501 provides the metadata format translation (see 103-113 of FIG. 1). The NOPWUSSQL1 Windows 2000 SQL server 503 is the primary data store for the warehouse, reporting, and web server. The SDEHAP01 Windows 2000 server 505 provides ETL transition utilities (see 117-125 of FIG. 1). The SDEHAP02 Windows 2000 server 507 provides survey data storage and report generation (see 101, 401-419 of FIGS. 1 and 4, respectively). The Webserver Windows 2000 server 509 provides client-accessible websites, for data entry by the physicians employing an Internet connectable device such as a personal computer as discussed further herein, utilizing the HTTP protocols.

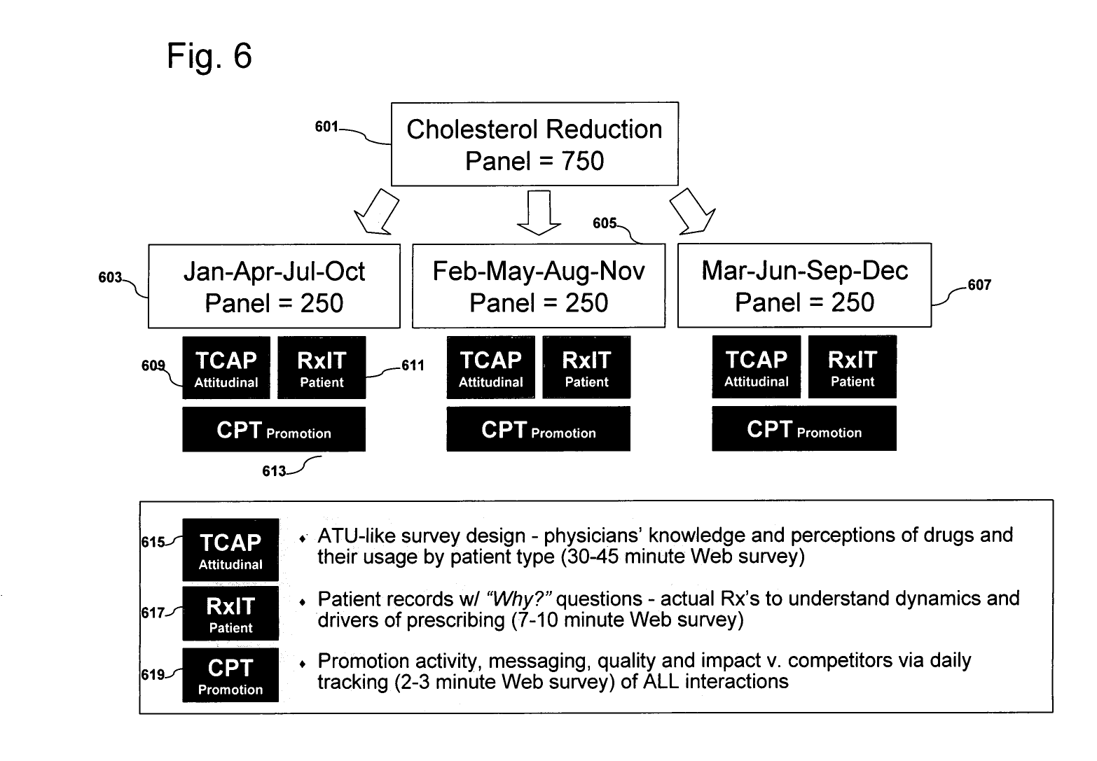

FIG. 6 describes a sample panel of physicians recruited to participate in the three components, or surveys (explained in more detail at FIGS. 6, 29-34). A panel of physicians is recruited, based on secondary prescribing data obtained from third parties. Frequently prescribing physicians are selected to determine potential panel members. These potential members are recruited through various forms of communication, including facsimile, telephone and email. Potential members are required to complete a background study, which requests information concerning the physician's practice, specialty, subspecialty and perceptions of different companies and sales representatives.

Based on the information provided, panels are established. In this example, the panel consists of 750 physicians 601, all of whom complete three sets of survey questions pertaining to cholesterol reduction brands. The panel is divided randomly into three groups 603, 605, 607. Individuals on the panel participate every third month, for four months out of the year. For example, a physician in group 1 would participate during the first month of every quarter, which are January, April, July and October 603. This methodology thus establishes a semi-longitudinal component, collecting information from physicians four times a year. Panel physicians complete all three surveys (TCAP 609, RxIT 611 and CPT 613) during the months in which they are active. A system of e-mail reminders are sent to panel physicians, indicating which surveys are available for completion and for what amount of time.

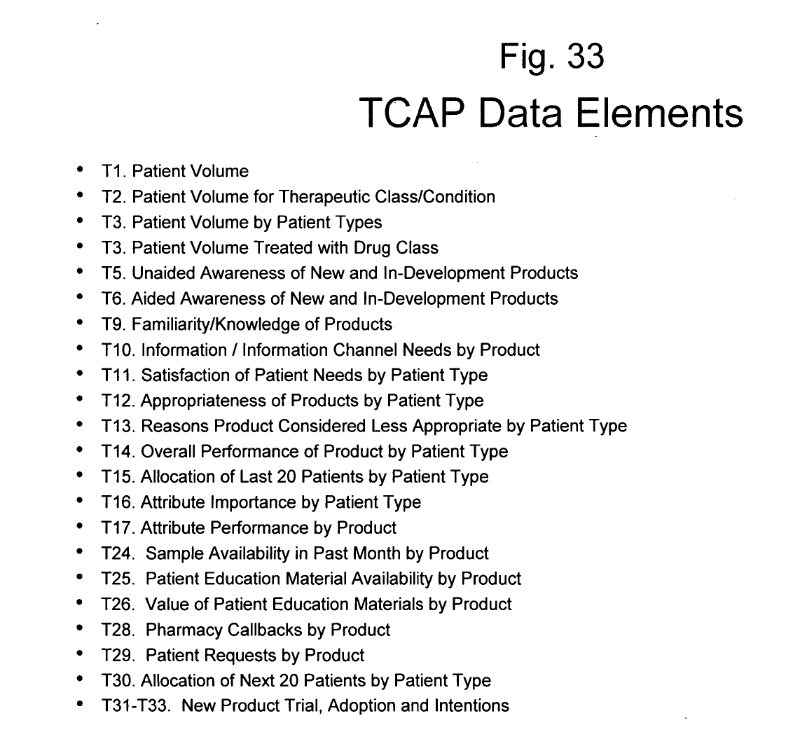

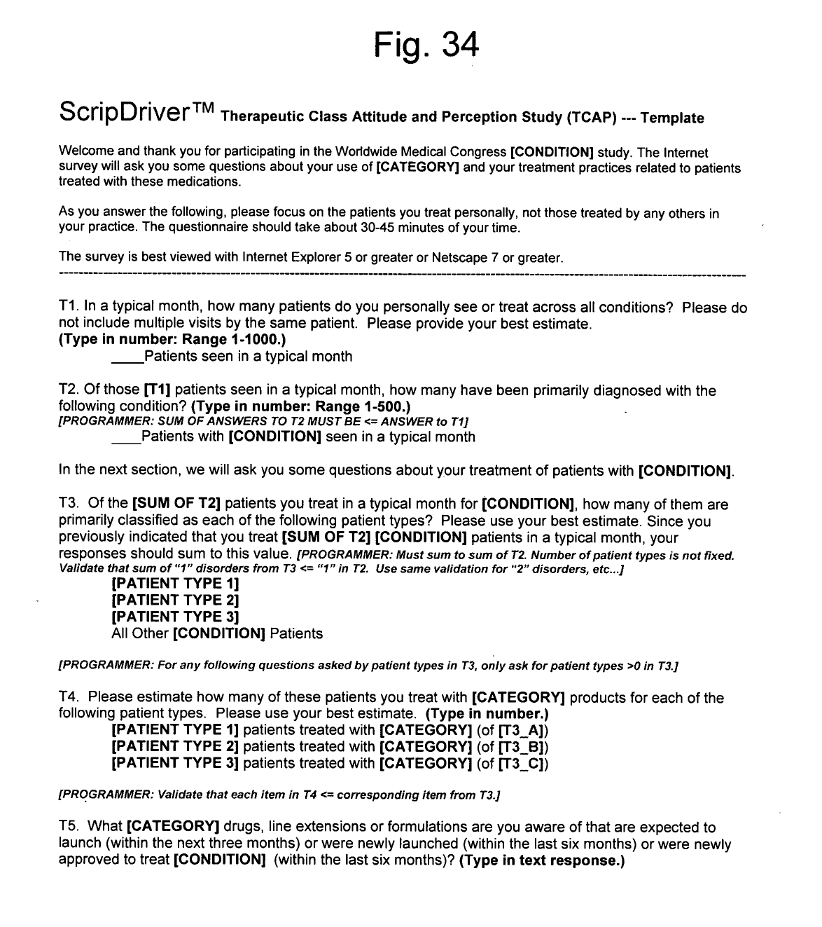

The first of the three modules is the Therapeutic Class Attitude and Perception Study (“TCAP”) 615. Physicians who are active on a particular panel complete an on-line survey, delivered to them on a secured, personalized website. Generally speaking, this 30-45 minute survey examines physicians' attitudes toward and perceptions of particular brands used or considered to treat patients with specific medical conditions. Physicians are asked, inter alia, to indicate what patient types they treat, and to indicate their perceptions of the different drugs for each of those patient types FIGS. 33, 34. Physicians complete one TCAP survey each month.

Active panel physicians next complete the second module—the Rx Intentions and Treatment Study (“RxIT”) survey 617, which targets actual prescription writing to assist companies in understanding dynamics and drivers of prescribing. Also web-based, the RxIT survey delivers patient records for the patient types the physicians actually treat, based on the physicians' responses to the TCAP survey. The RxIT survey is approximately 7-10 minutes long for each patient record. Each physician completes between 10 and 12 RxIT surveys in the month they are participating.

While participating in the TCAP and RxIT surveys, physicians also participate in the Continuous Promotion Tracking (“CPT”) study 619, which is a daily tracking study of all physician encounters with pharmaceutical sales representatives. The CPT is also completed via the physicians' same personalized webpages used to deliver the TCAP and RxIT surveys. Physicians may complete as many CPT surveys as necessary.

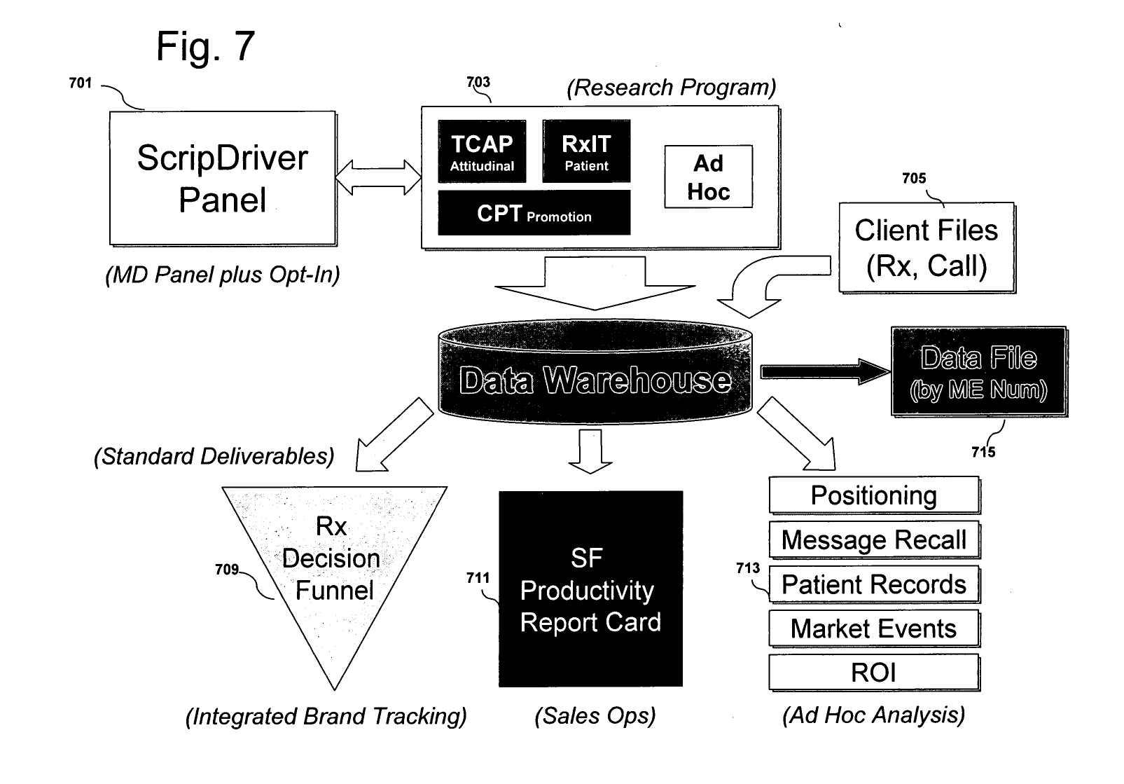

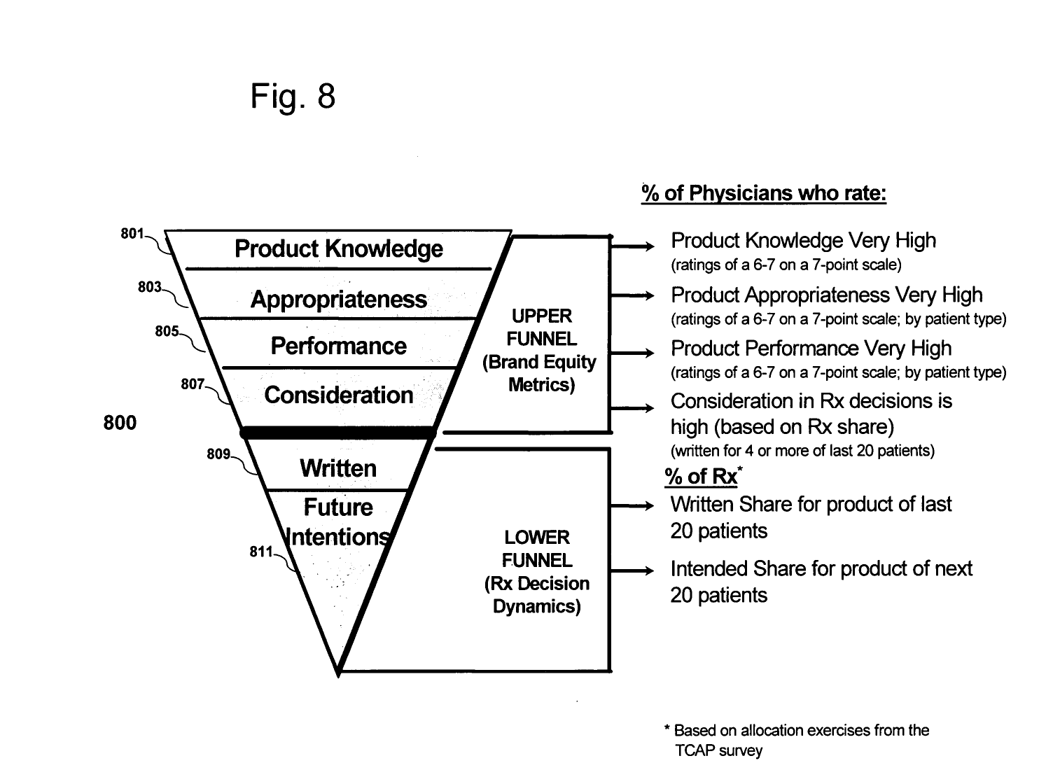

FIG. 7 is a high-level overview of the process, from panel recruitment through report generation. The physician panel 701, recruited on the basis of secondary prescribing data. Once recruited onto the panel, physicians complete the three surveys 703 for the months in which they are active. The “ad hoc” box 703 indicates that market issues or market events may arise, which merit additional survey questions to be posed to the panel. For example, if warnings concerning diabetes risk with atypical antiphychotic drugs arise, the panelists may be asked about their perceptions on the topic, and their answers may be integrated with one of more of the three surveys. All of the data is fed into the data warehouse (described in detail at FIGS. 1-4). Additionally, company files 705 exist, which may not flow directly into the system's data warehouse, but are integrated with the data for analysis purposes. Companies may provide IMS or NDC data concerning prescribing, as well as call activity data. For example, some companies' representatives record how many times they visit certain physicians each month. Company files 705 thus highlight the client files that may be used for analytical purposes. The system may also export data out of the warehouse 707 as a data file at the ME number level 715 as a partially open source product, thus allowing pharmaceutical companies to work with physician-level data themselves for internal and analytical purposes. “Rx Decision Funnel” 709 is described in more detail at FIG. 8. A Sales Operations deliverable 711 is a future planned enhancement to the product. The system may perform an ad hoc analysis 713, using the ad hoc survey data. Thus, non-subscribers to the invention may utilize limited data to perform a patient record analysis or message recall analysis to supplement other research in which they may be engaged.

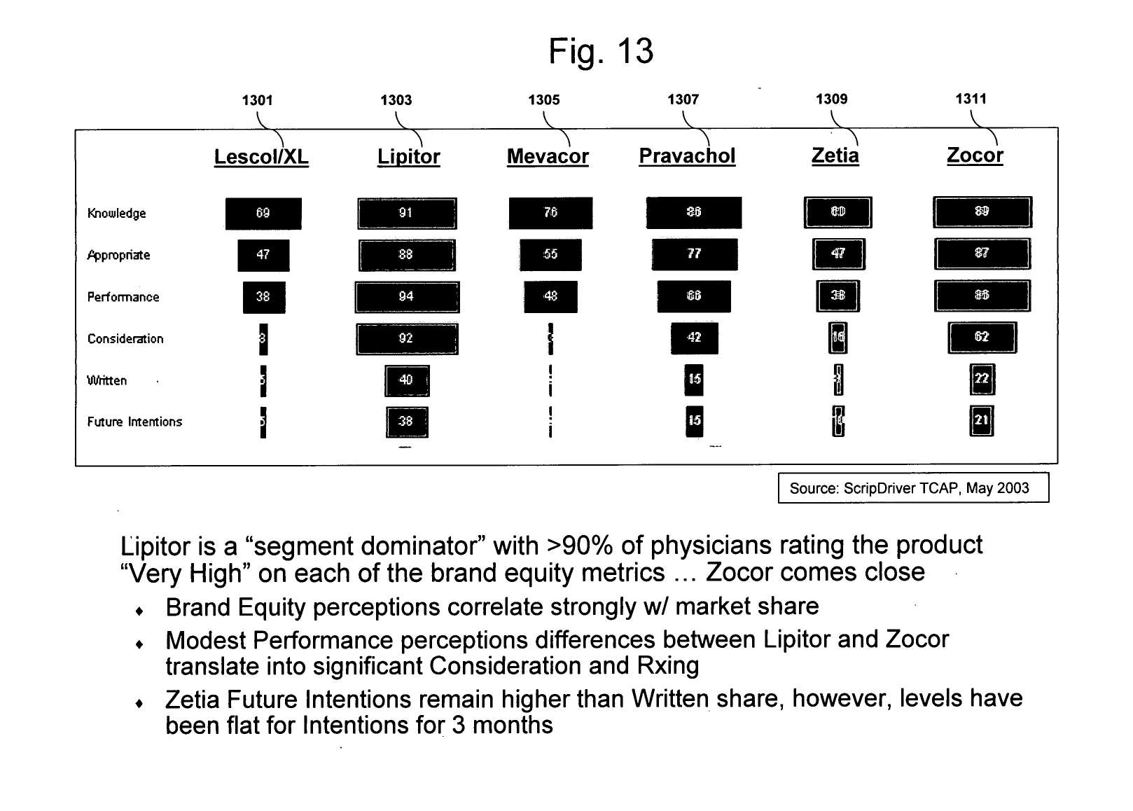

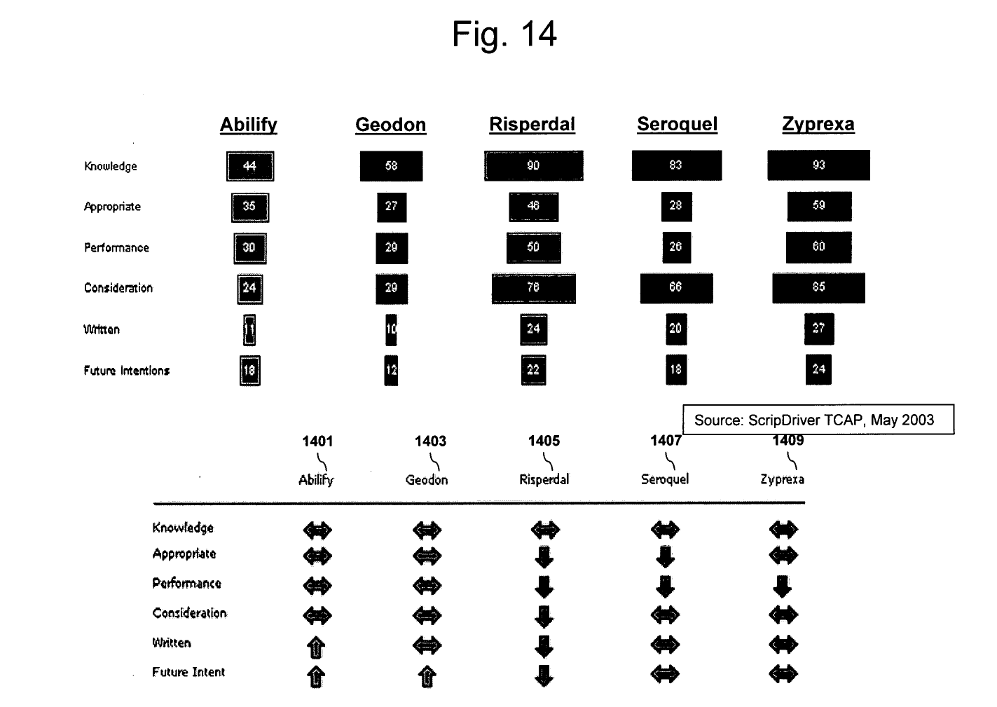

FIG. 8 represents a “brand funnel,” which is essentially a snapshot of how a brand fares both in terms of attitudinal perceptions (from the TCAP survey) and physician prescribing (from the RxIT survey), as measured in six major categories. These “funnels” are built both by brand and by patient type, thus enabling a company to evaluate how its brand ranks in comparison to other brands in a competitive set (see FIGS. 13-14) and how a product is positioned differently across different patient types. The top half of the funnel is comprised of the following four categories, which are derived from the TCAP survey and are collectively referred to as “Brand Equity Metrics”: Product Knowledge 801; Appropriateness 803; Performance 805; and Consideration 807. These categories are designed to measure a product's profile and how physicians perceive that profile. The bottom half of the funnel contains two categories, which are derived from the RxIT survey, and are collectively referred to as “Rx Decision Dynamics”: Written 809 and Future Intentions 811. These two categories are designed to measure a physician's prescribing patterns and future intentions for prescribing the brand. A more thorough examination of each major, “brand funnel” category will illustrate how integrated reports are ultimately generated via the surveys.

The “Knowledge” category 801 is measured by question TCAP T9: “How knowledgeable are you about [PRODUCT]?” in FIGS. 33 and 34. The physicians are asked to respond using a scale of 1 to 7, where 1 is “Not at all Knowledgeable” and 7 is “Extremely Knowledgeable.” The funnel metric reported is the percent of physicians that assigned a 6 or 7 to that category. Knowledge is a product-level metric and is not asked by patient type.

The “Appropriateness” category 803 is measured by TCAP T12 in FIGS. 33 and 34: “Given the product profile and indications, please indicate how appropriate you think each [PRODUCT] is for the treatment of [PATIENT TYPE] patients.” The physicians are, again, asked to respond concerning each patient type, using a scale of 1 to 7, where 1 is “Not at all Appropriate” and 7 is “Extremely Appropriate.” The funnel metric reported is the percent of physicians that assigned a 6 or 7 to that category. In the Brand Comparison view funnels, the “Appropriateness” values reported represent derived overall Appropriateness, weighted by patient type volume at the physician-level.

The “Performance” category 805 is measured by question TCAP T14 in FIGS. 33 and 34: “Please rate the performance of [PRODUCT] for the treatment of [PATIENT TYPE] patients. Please respond using a scale of 1 to 7, where 1 is ‘Performs Extremely Poorly’ and 7 is ‘Performs Extremely Well.’” The funnel metric reported is the percent of physicians that assigned a 6 or 7 to that category. Performance is a patient type-level metric. In the Brand Comparison view funnels, the Performance values reported represent derived overall performance, weighted by patient type volume at the physician-level.

The last Brand Equity metrics funnel category is “Consideration,” 807 which is derived from question TCAP T15 in FIGS. 33 and 34: “Please think about your last 20 [PATIENT TYPE] patients prescribed [CATEGORY]. For how many patients did you prescribe each of the following drugs?” Consideration is then measured by the percent of physicians who gave a product “High Consideration” in their prescribing decisions. “High Consideration” is defined as writing the product for 4+ patients of their last 20 patients treated with the drug class or category. Consideration is a patient type-level metric. In the Brand Comparison view funnels, the Consideration values reported represent derived overall consideration, weighted by patient type volume at the physician level and, more specifically, the percent of physicians who prescribed the brand for 4 or more of the last 20 patients.

The first category in the lower, Rx Decision Dynamics funnel is “Written” (written share) 809, which is derived from question TCAP T15 in FIGS. 33 and 34: “Please think about your last 20 [PATIENT TYPE] patients prescribed [CATEGORY]. For how many patients did you prescribe each of the following drugs?” “Written” reports the mean share of the product based on current prescribing of the physician's last 20 patients treated with the drug class or category. Written is a patient type-level metric. In the Brand Comparison view funnels, the written values reported represent derived overall written share, weighted by patient type volume at the physician-level.

The second category in the lower funnel is “Future Intentions” (intended share) 811, which is derived from question TCAP T30 in FIGS. 33 and 34: “Keeping in mind your experience with your last 20 [PATIENT TYPE] patients and any recent market events, please think about the next 20 [PATIENT TYPE] patients for whom you will prescribe [CATEGORY]. For how many will you prescribe each of the following drugs?” Intentions reports the mean share of the product based on future prescribing of their next 20 patients treated with the drug class or category. Intentions is a patient type-level metric. In the Brand Comparison view funnels, the Intentions values reported represent derived overall intended share, weighted by patient type volume at the physician-level.

As illustrated in FIG. 8, brand funnels are derived to allow pharmaceutical companies to examine a hierarchy of brand equity categories, and to examine how those categories translate into prescribing for their brands. Additionally, the funnels enable companies to understand how their funnel profiles compare with those for competitive brands, to understand potential stopgaps within their funnel and areas for improvement, and to understand changes over time. Companies may then determine how to improve their progress in one or more categories to ultimately increase prescribing.

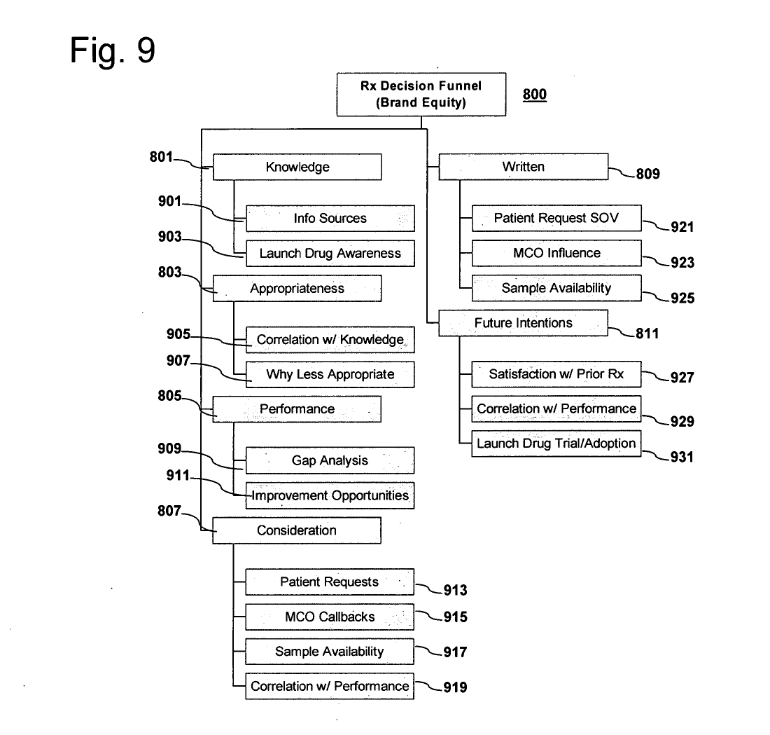

FIG. 9 illustrates “drill down” diagnostic elements, which are factors potentially affecting a brand's success in one or more of the six major, brand funnel categories. Two different drill downs related to the Knowledge 801 are identified. The first drill down for Knowledge is “Information Sources,” 901 such as website referrals, the physicians' time with the sales representatives or clinical studies. This drill down would identify from the TCAP study any relevant information channels that the company can use to help increase physician knowledge for their brand. “Launch Drug Awareness” 903 is another drill down for Knowledge, and examines awareness levels for launch products. When a new product enters the market, the TCAP measures both unaided and aided awareness levels that would relate to physician knowledge as to those different brands.

The Appropriateness funnel category 803 contains two different drill downs, both of which are examined in the TCAP study to assist companies in understanding the appropriateness levels reported. First, “Correlation with Knowledge” 905 examines the relationship between product Appropriateness and product Knowledge, and enables companies to understand how knowledge of their product will relate to the Appropriateness of the brand, and whether increasing knowledge will result in increasing appropriateness for the brand. Second, “Why Less Appropriate” 907 examines physician-reported reasons as to why a product is considered less appropriate. Exemplary factors include safety, side effects, or nonmedical factors such as managed care influence or sampling. The reports thus assist companies in understanding the relative influence of each of those factors.

The Performance funnel category 805 also contains two drill downs from the TCAP. First, “Gap Analysis” 909 examines specific product attributes that are specific to each therapeutic class, and analyzes the data in a manner to help companies understand competitive advantages and disadvantages of each product on each attribute. Second, “Improvement Opportunities” 911 explains the same set of attributes in a different manner of examining the same data, and examines the impact of attribute performance on overall Performance perception. For example, this drill down might help a company examine what effect a change in Performance perceptions of a brand's safety profile will influence the overall Performance perceptions that a physician has with that brand. Companies can thus understand the impact, referring back specifically to the funnel.

The Consideration funnel category 807 contains four different drill downs from the TCAP study, the first three of which are “Patient Requests,” 913 managed mare influence 915 and “Sample Availability” 917. These drill downs are essentially commercial drivers that may influence a physician's decision to consider a brand. In the fourth drill down, “Correlation with Performance,” 919 Consideration is correlated with Performance. This correlation enables a company to measure what part of the impact of Consideration is brand equity- or performance-driven, versus what percent of the impact is commercial driven.

The Written funnel category 809 (at the Rx Decision Dynamics, lower half of the funnel), contains three commercial-driven drill downs from the RxIT patient records survey. First, “Patient Requests SOV” 921 enables the company to measure the share of patient requests voiced, and examines the relative patient request across the competitive set. Second, the system measures the managed care influence” 923 as reported in the patient records at the patient level, and thirdly, measures “Sample Availability” 925 reported by the physician as drivers of Written share.

The Future Intentions funnel category 811 contains three different drill downs. The first is “Satisfaction with Prior Rx,” 927 which reports the physicians' satisfaction with prior prescribing of the brand. Prior satisfaction affects future plans to prescribe the brand, and is derived from the RxIT patient record study. Second, the system correlates the Future Intentions with Performance perceptions 929, with the goal of integrating the bottom half of the funnel with the top half. Third, the “Launch Drug Trial/Adoption” 931 drill down examines planned future prescribing of launch products, and specifically measures time to trial and time to adoption. Companies may thus understand the planned uptake for future products and future prescribing.

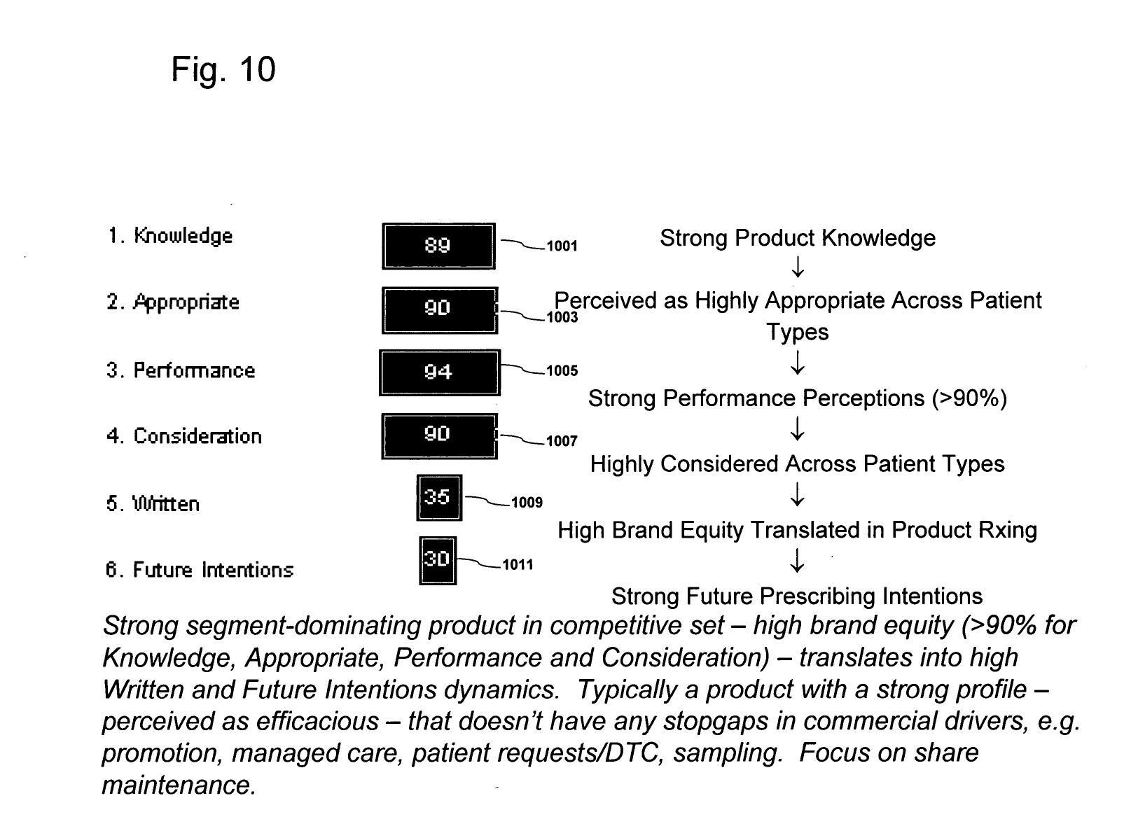

FIGS. 10-12 are exemplary applications of the funnel framework, interpreting the survey results for a company's brand or a competitor's brand. FIG. 10 exemplifies an “ideal” funnel profile, or a “segment-dominating product.” As illustrated, a segment dominator shows a “high” brand equity for the Knowledge 1001, Appropriateness 1003, Performance 1005 and Consideration 1007 layers of the funnel, where “high” indicates that greater than 90% of physicians indicated high (as previously defined with respect to each funnel category) perceptions of the product for Knowledge, Appropriateness, Performance and Consideration. High brand equity for a segment dominator translates into high prescribing decisions dynamics and thus high Writing 1009 and high Future Intentions 1011. Typically, the type of product illustrated by this type of funnel profile would be perceived as efficacious, would meet all the product profile barriers that it would need to meet in order for physicians to perceive it highly, and would not usually have any significant obstacles in the commercial drivers, promotion strategy, managed care strategy, patient requests or sampling. Companies producing brands illustrated by this type of funnel would typically be interested in focusing more on share maintenance, particularly with new brands entering the market.

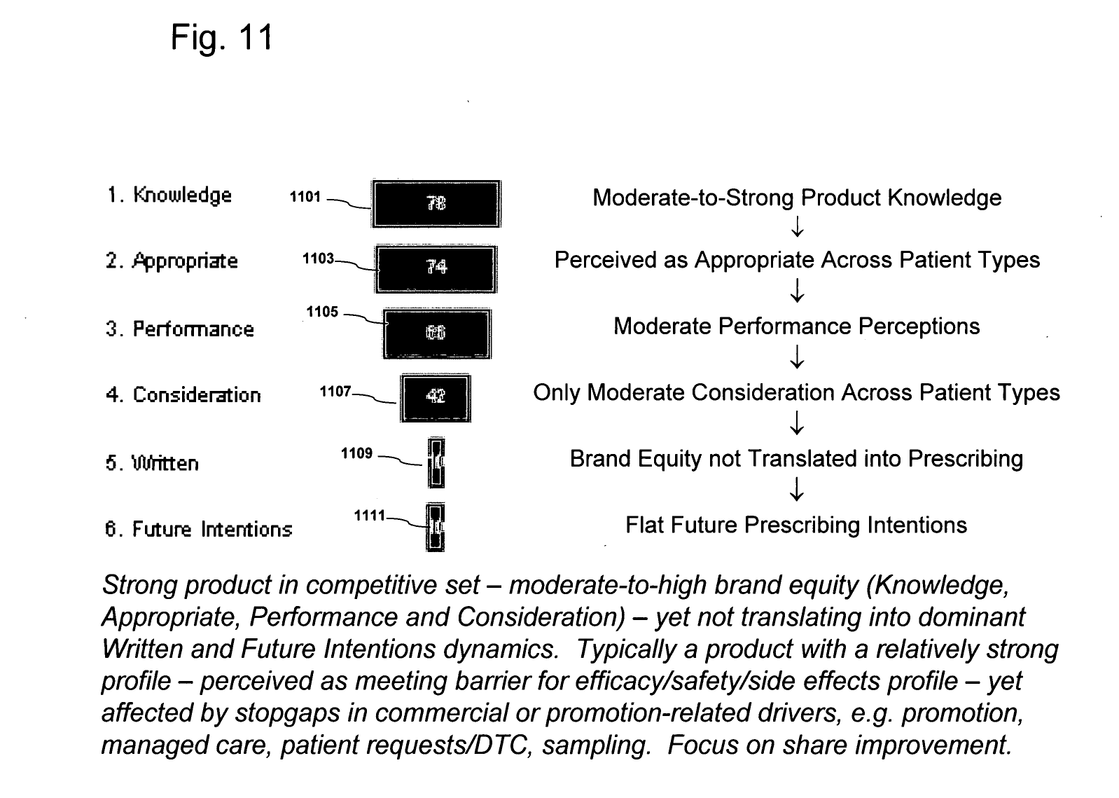

FIG. 11 exemplifies a “top-heavy” funnel. Similar to the segment-dominator funnel exemplified in FIG. 10, the product is relatively strong compared to the competitive set. The Brand Equity shown in the top of the funnel is moderate to high 1101-1107, yet this strong brand equity does not translate into dominant Writing 1109 and Future Intentions 1111 in the bottom half of the funnel. Instead, the brand has a 10% product share 1109 and flat Future Intentions 1111. A product that shows this type of profile has a relatively strong profile, and many physicians still perceive the brand very highly on Appropriateness and Performance, and consider it very strongly. Therefore, the brand is likely perceived as meeting the minimum barrier for its profile for efficacy, safety and side effects. Yet, the brand is affected by problems with either commercial- or promotion-related strategy. In this case, the company producing the brand would focus on share improvement by identifying any of those obstacles in their commercial or promotional strategies, while continuing to improve their brand equity as much as possible.

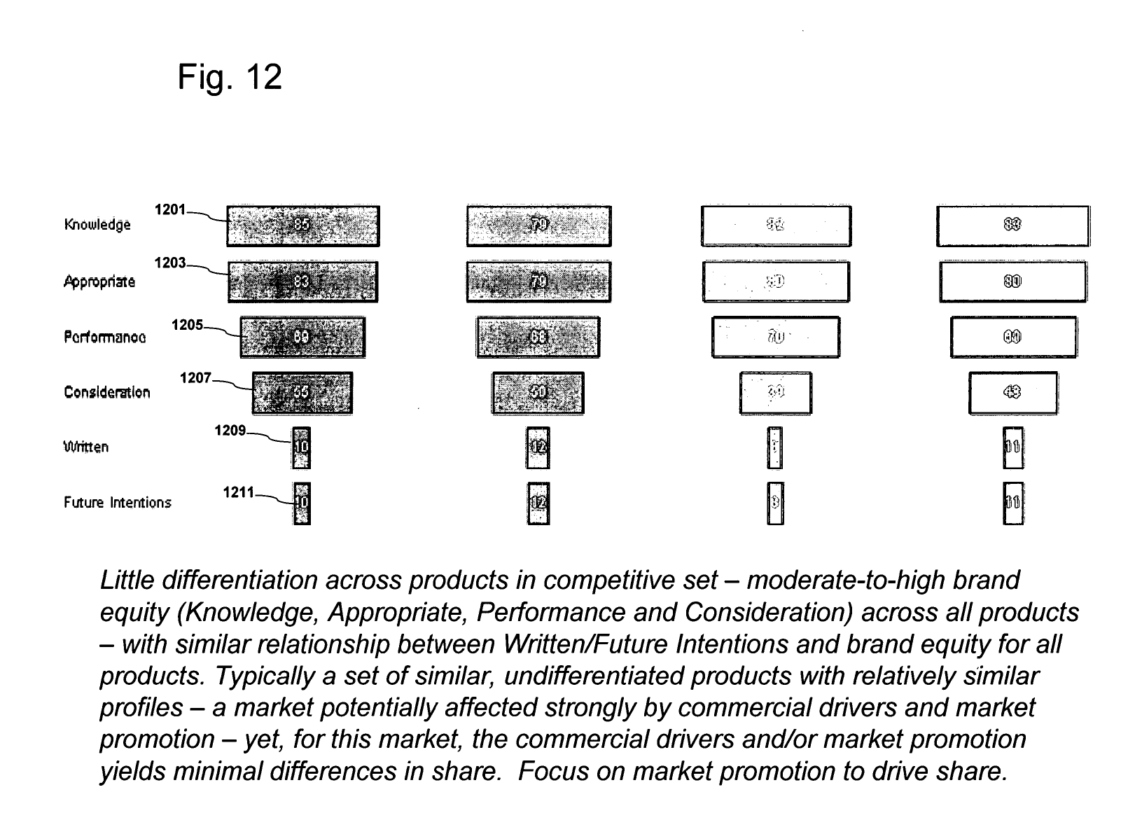

FIG. 12 exemplifies not an individual funnel picture, but a competitive pharmaceutical set in a particular market, and illustrates a relatively undifferentiated market profile by examining the product from funnel shapes. This competitive set exemplifies few differences, as all of the brands shown have moderate to high Brand Equity 1201-1211 (as defined by the categories in the top half of the brand funnel). Each of these products bears a similar relationship between the top half of the funnel and the bottom half of the funnel—i.e., similar relationships between their Written and Future Intentions and their Brand Equity. FIG. 12 thus contains a set of very similar and undifferentiated products with very similar profiles 1201-1211 in the market, which have the potential to be highly affected by commercial drivers and market promotions. For this market in particular, the commercial drivers and market promotion yield very minimal differences in share. Thus, a company might benefit from focusing on market promotion to increase its brand's written share.

FIG. 13 highlights the Rx Decision funnels from a competitive set. Lipitor 1303, for example, is represented by a “segment-dominator” funnel shape, as shown in FIG. 10, and Zocor 1311 is represented by more of a top heavy funnel, as exemplified in FIG. 11. FIG. 14 shows another competitive set of funnels, and, at 1401-1409, exemplifies “exception reporting,” which highlights any statistically significant changes between the current month (i.e., the data collection period) and the previous month on each of the funnel layers. For example, Abilify 1401 underwent no significant change in Knowledge, Appropriateness, Performance and Consideration, but underwent a significant increase in Written and Future Intentions between the current and previous month's data.

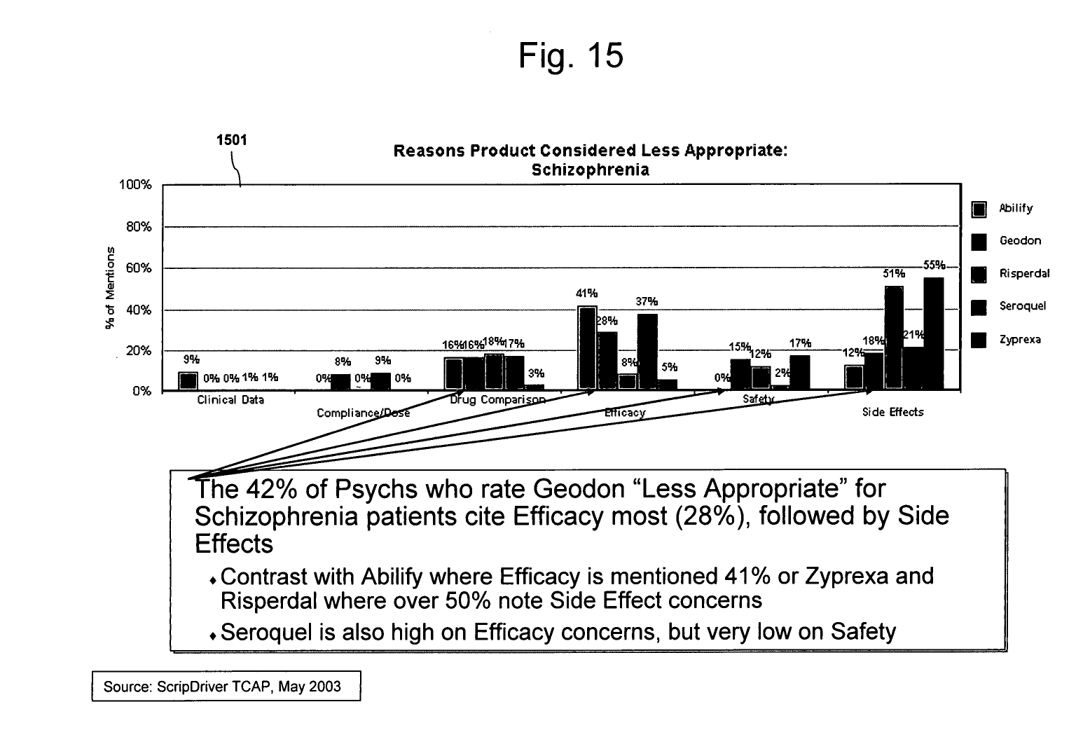

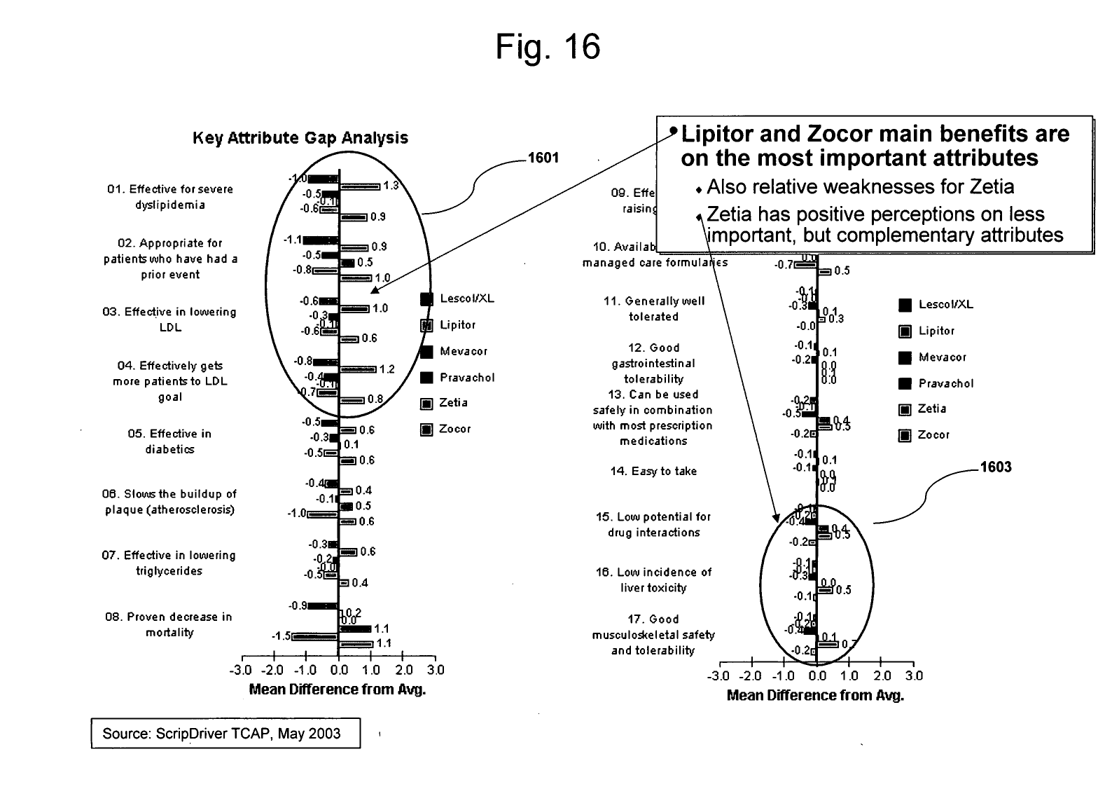

Focusing again on the drill downs, as listed in FIG. 9, FIG. 15 is a drill down for Appropriateness on reasons why a product is considered less appropriate for a particular patient type. Drill down 1501 highlights an example from the atypical antipsychotic market of reasons a product is considered less appropriate for schizophrenia, including clinical data, compliance and dosing. Drill down 1501 also illustrates the differences in reasons why one brand may be considered less appropriate than others. In this example, 42% of the physicians who rated Geodon “less appropriate” for schizophrenia patients cited efficacy most, followed by side effects. In contrast, over 50% of physicians noted side effect concerns for Risperdal and Zyprexa.

FIG. 16 is a drill down for Performance and contains a Key Attribute Gap Analysis, which displays attributes in descending order of derived importance. Thus, the first attribute, “Effective for severe dyslipidemia,” is the most important attribute derived from physician data. Similar to FIG. 15, FIG. 16 is designed to show competitive strengths and weaknesses. Graph bars to the right side (the positive axis) indicate a competitive advantage of that brand, and bars to the left side (the negative side of the axis) highlight competitive disadvantages. In this exemplary report, Lipitor and Zocor are the market leaders on most of the more important attributes 1601, and are rated lower on the less important attributes 1603.

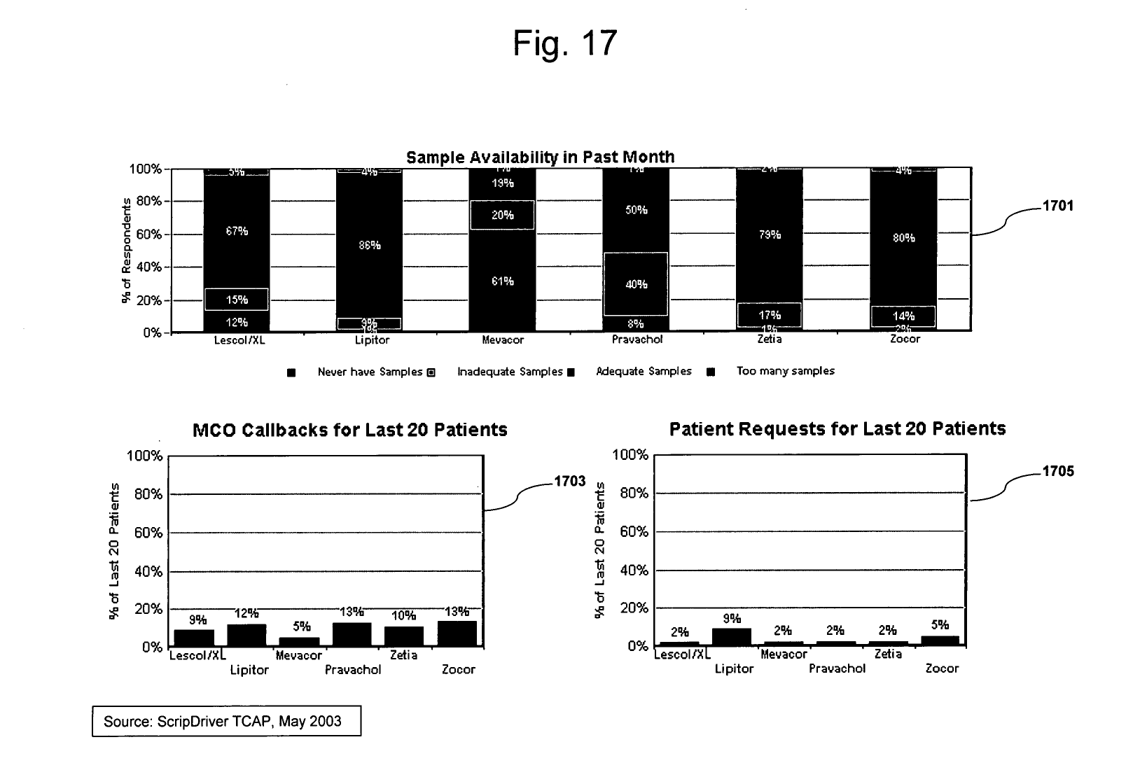

FIG. 17 shows commercial variables (set forth in FIG. 9, 913-917, 921-925) collected from reports. Shown is a competitive set 1701 of physician-reported sample availability in the past month, for the distribution of sample availability among the panel physicians (such as what percent of physicians report they never have samples, have inadequate samples, have adequate samples or have too many samples). For example, 67% of physician panelists indicated they had inadequate samples of Lescol/XL, while 5% indicated they had too many samples. Report 1703 shows the percent of managed care callbacks concerning each brand. For example, physicians report recalling significantly less Managed Care Callbacks from Mevacor. Report 1705 shows patient requests (as reported by physicians) for the last 20 patients, and in this example, patient requests are typically dominated by Lipitor, followed by Zocor.

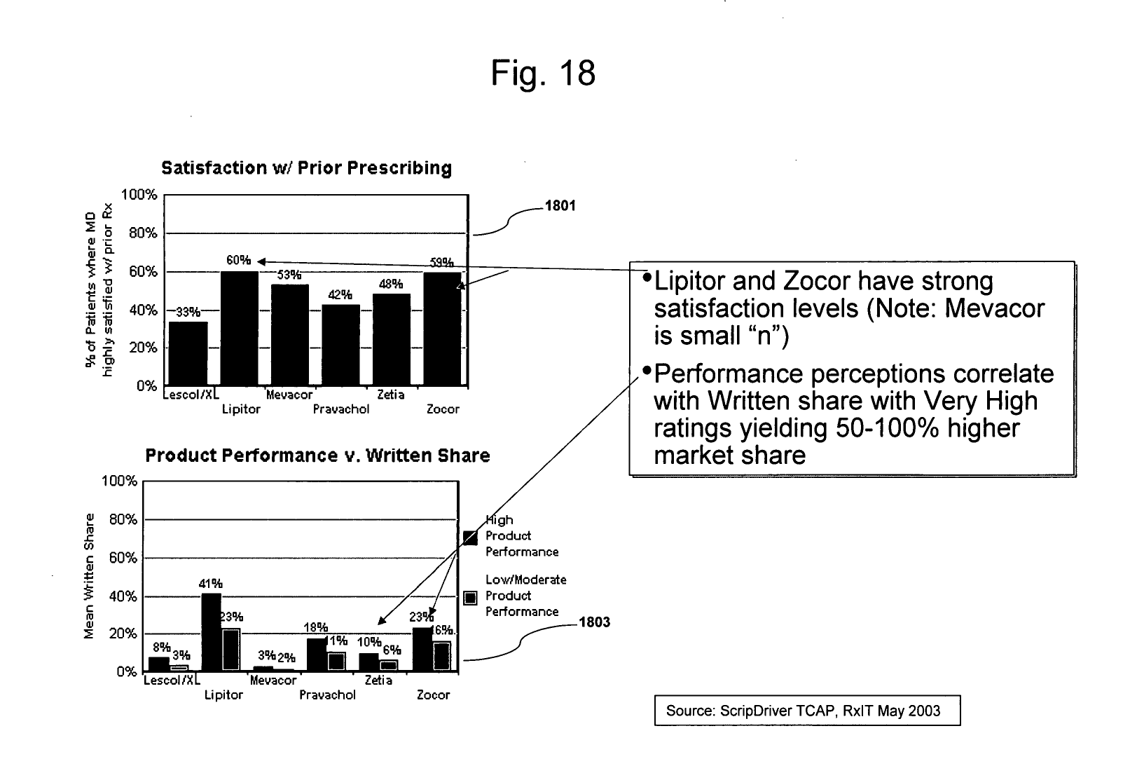

FIG. 18 is an exemplary report integrating Performance perceptions (from the TCAP survey) with Satisfaction with Prior Prescribing (from the RxIT survey). Report 1801 shows Satisfaction with Prior Prescribing, and is an example of a drill down for Written prescriptions that comes from patient records from the RxIT survey. Physicians are asked in the RxIT survey to indicate their satisfaction with any brands the patient was taking when they saw the patient. Physicians have reported strong satisfaction levels for Lipitor and Zocor in this market. Report 1803 highlights a cross sectional analysis, which divides physicians into two groups based on their perceptions on certain variables. Based on those groups, the relationship between those groups and a different variable is examined. In report 1803, physicians were divided into groups or cohorts based on performance perceptions. As an example, the report 1803 separates physicians reporting high performance perceptions for Lipitor from those reporting low or moderate perception, and compares the written share for Lipitor for those two groups. This example illustrates that physicians with high Performance perception for Lipitor report 41% as their Lipitor Written share, while those with low or moderate Performance perception report 23%. Thus, the cross-sectional analysis reveals that Performance perception has a significant impact on Written share, and quantifies the impact in terms of prescribing of increasing Performance perceptions for this brand.

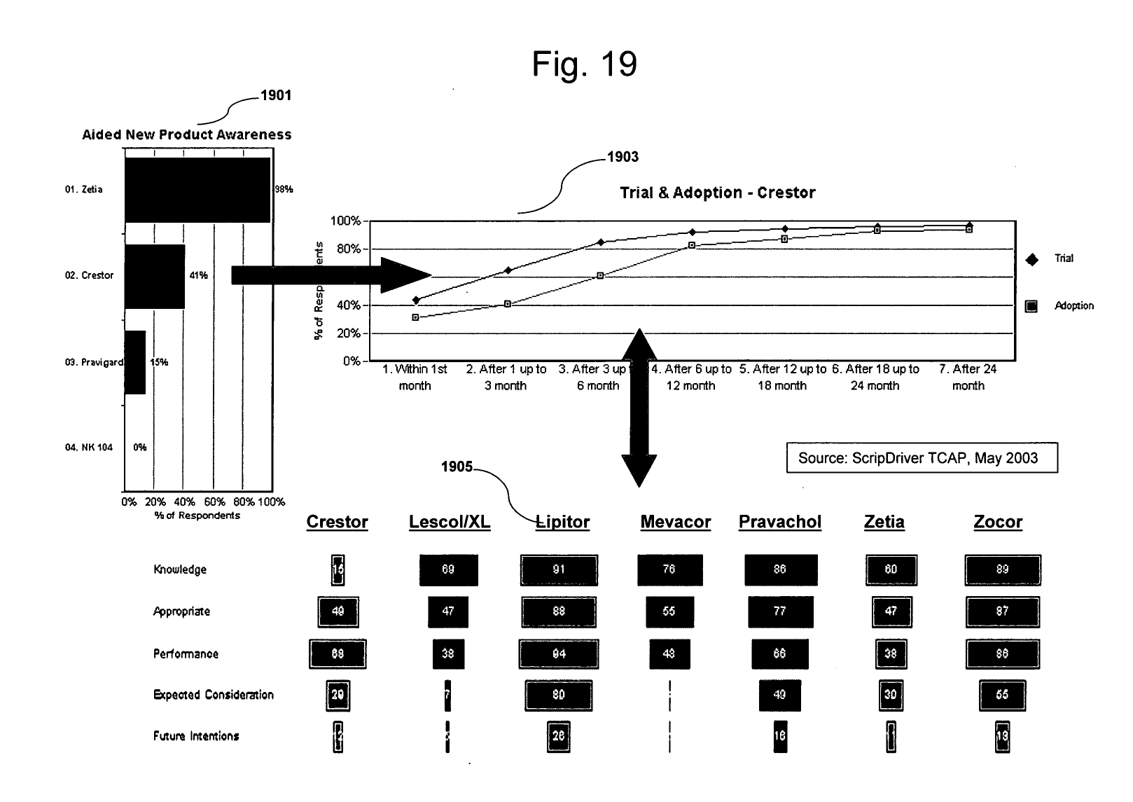

FIG. 19 shows launch tracking performed for new product launches. In this example, all of the reports highlight Crestor, a new product in the Lipids market that is expected to be a highly successful product. Report 1901 shows a measure of aided awareness of new products, which, for Crestor, was 41% for that data collection period—i.e., 41% of physicians were aware of (i.e., knew of) Crestor. Report 1903 shows how long physicians will take to “try” and “adopt” Crestor. “Trial” signifies the first time a physician would try the product and “Adoption” signifies the point at which the product would become a standard part of their treatment patterns. In this example, over 40% of the “aware” physicians reported their intention to “try” Crestor within the first month, while only about 30% of those physicians will “adopt” it within the first month. Report 1905 generates pre-launch funnels for newly launched brands (here, Crestor). The report 1905 generated a funnel for Crestor before its launch to understand currently how physicians perceive its Appropriateness, Performance and Consideration once the product is FDA-approved and available, and what its future mean share will be once Crestor is approved and available. A comparison in report 1905 of the multiple product funnels demonstrates that the top half the Brand Equity funnels for the existing, older products remain the same. Consideration and Intentions, however are impacted by Crestor's market launch. These funnels are different from each other (and illustrate, for example, the brand share of Lipitor after Crestor enters the market), thus analyzing the gain and loss of each of the inline products when a new competitor enters the market.

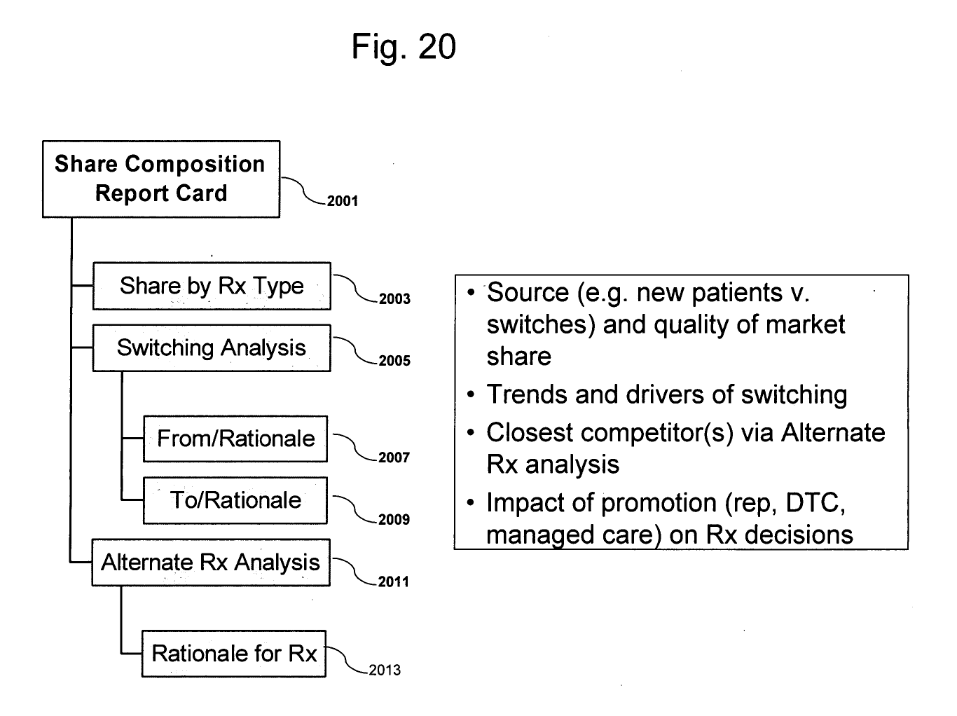

FIG. 20 contains drill down diagnostics for Brand Loyalty and Switching. The Share Composition Report Card 2001, is composed of 1) share by prescription type 2003; 2) switching analysis 2005, which includes switching from 2007 or to 2009 brands and the reasons for this switch; and 3) alternate prescription choice 2011, which examines the rationale for prescribing 2013.

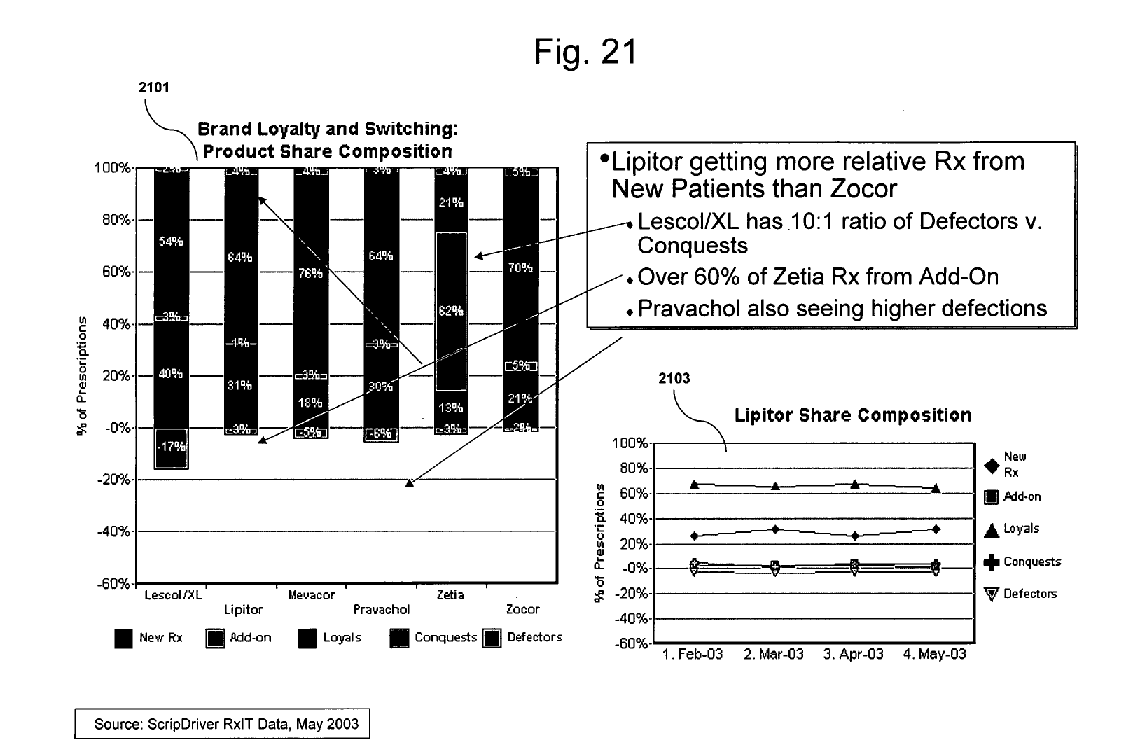

FIG. 21 highlights the share composition report card, and reports the actual source of business for each brand in the market. For example, in report 2101, 31% of Lipitor's business comes from new patients, 64% comes from refills or continuations, 1% comes from add-ons to other treatments and 4% comes from switches to the brand. Lipitor loses 3% of its share to defection (i.e., switching to another brand or discontinuation). Report 2103 examines sources of business on an individual brand level trended over time.

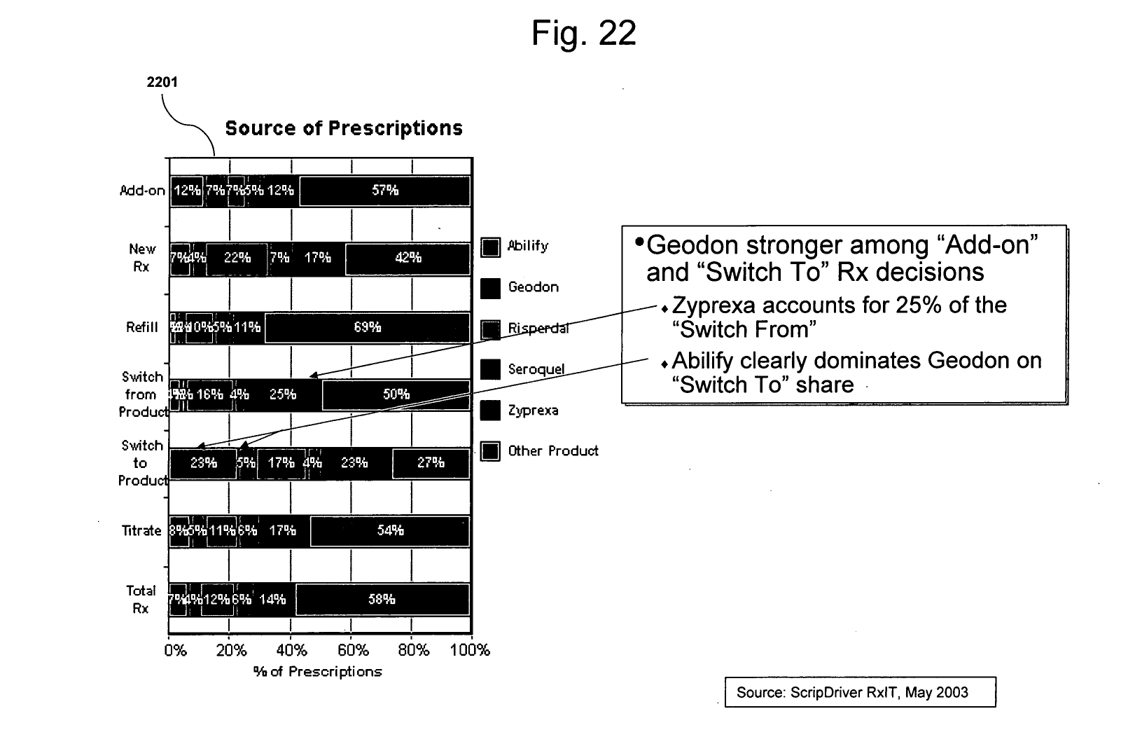

FIG. 22 shows the share of different brands by prescription by type. Report 2201 examines the share of new prescriptions, the share of titrations and which products are dominating different prescription types, enabling companies to understand their positioning in relative usage.

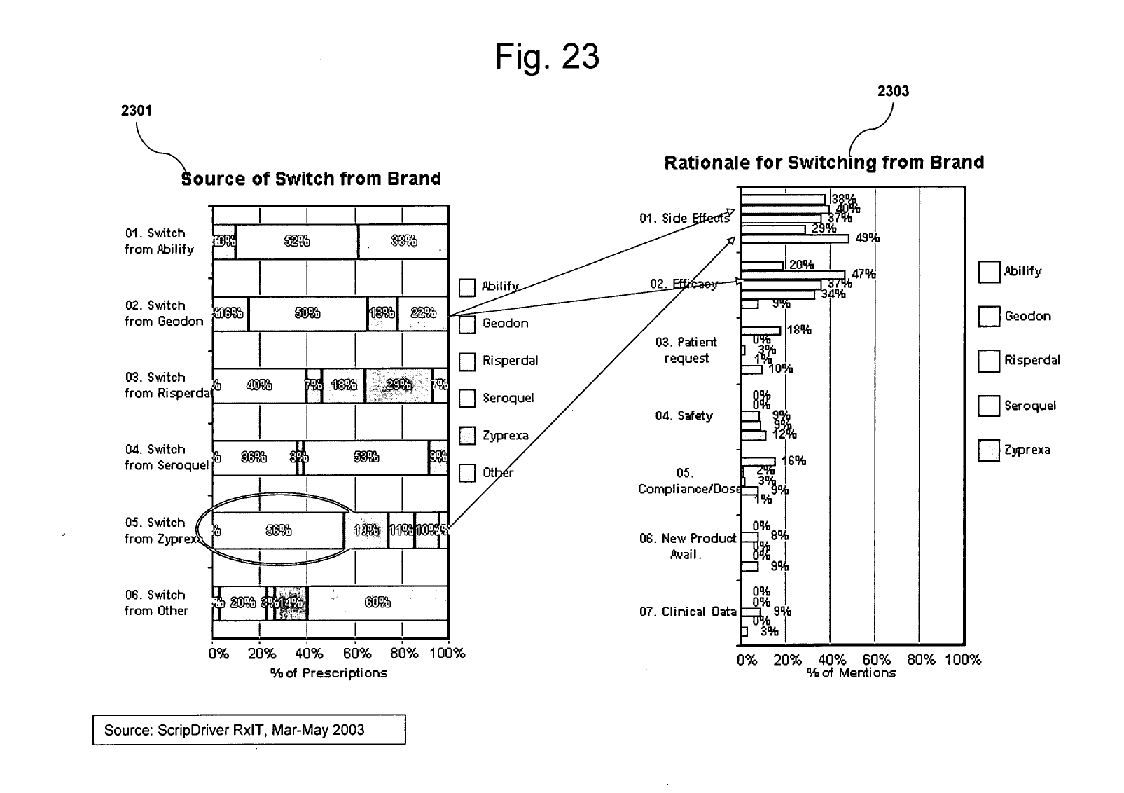

FIG. 23 shows a “switching analysis.” Report 2301 examines the share of each brand by “source switches.” For example, a company may look to source switches from Abilify to understand what percent of switches from Abilify went to Risperdal, which, in this example, was 52%. Companies may thus understand the switching dynamics in a greater level of detail. Report 2303 highlights attitudinal data and attitudinal depth collected in the RxIT patient record to supplement it, and is focused on diagnostic information, particularly physician-reported reasons for switching. These reasons include side effects, safety and managed care, and thus a blend of commercial and product profile factors. For example, 49% of physicians reported side effects as a reason for switching from Zyprexa.

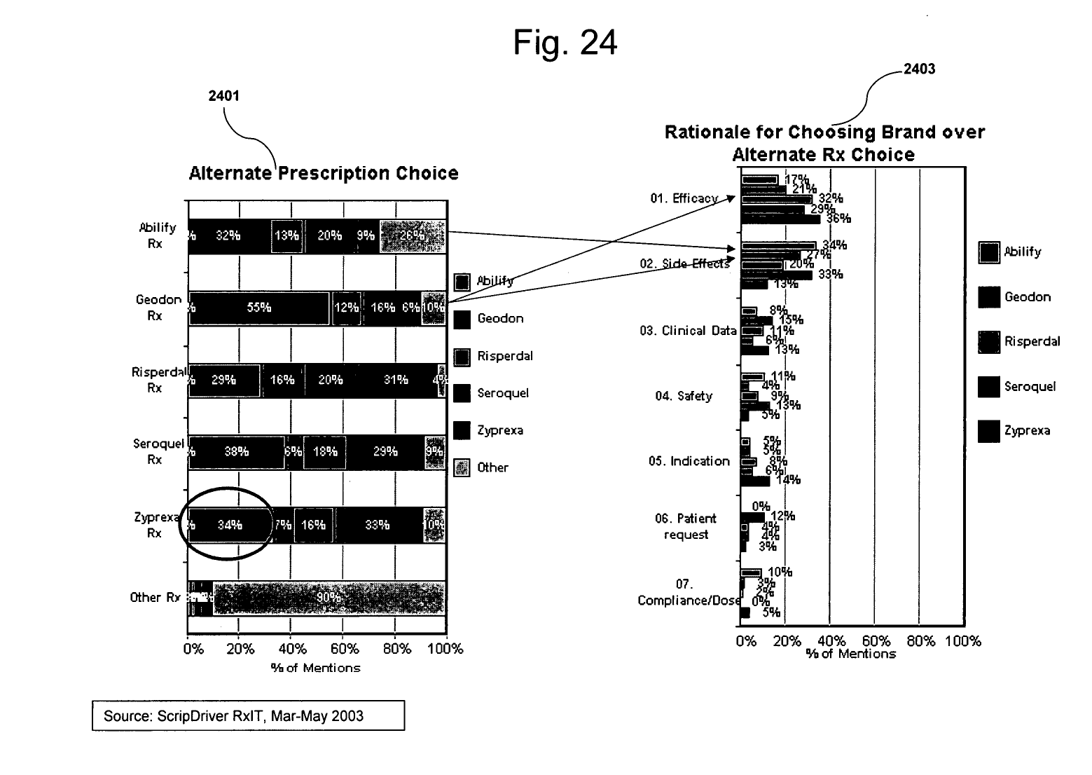

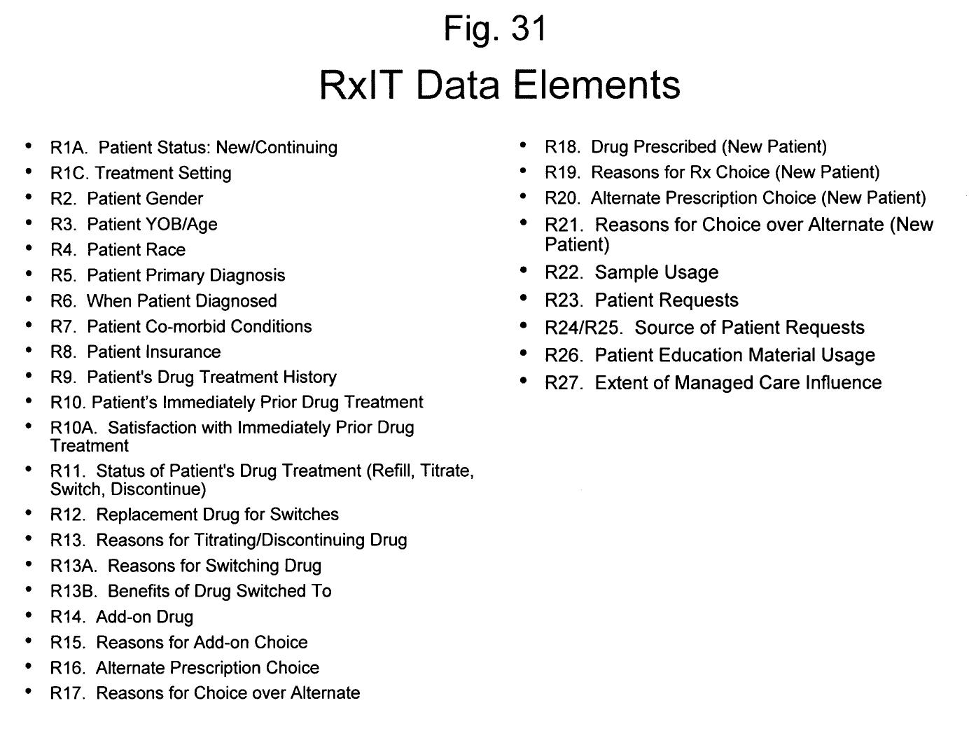

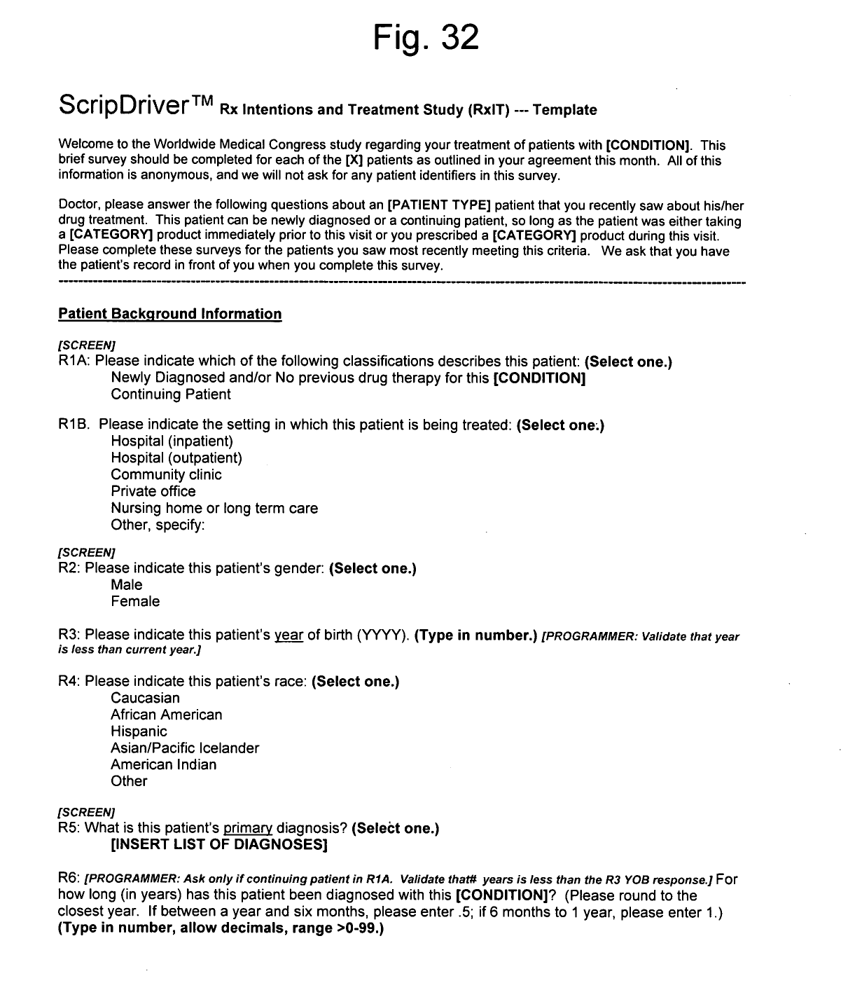

FIG. 24 exemplifies an alternate prescription choice analysis, derived from the RxIT patient record data. This analysis allows companies to evaluate their closest competitors or second competitors in the market with respect to one or more of their brands. The RxIT survey (FIG. 31-32) asks physicians, in the event that the drugs they prescribe for a particular patient were not available (whether due to resource issues or managed care issues, for example), to indicate alternate prescription choices. As shown in report 2401, the reports also assist companies in understanding the reasons for the physician's first choice over the alternate prescription choice, and how that company's brand might ultimately become the physician's first choice rather than the alternate choice.

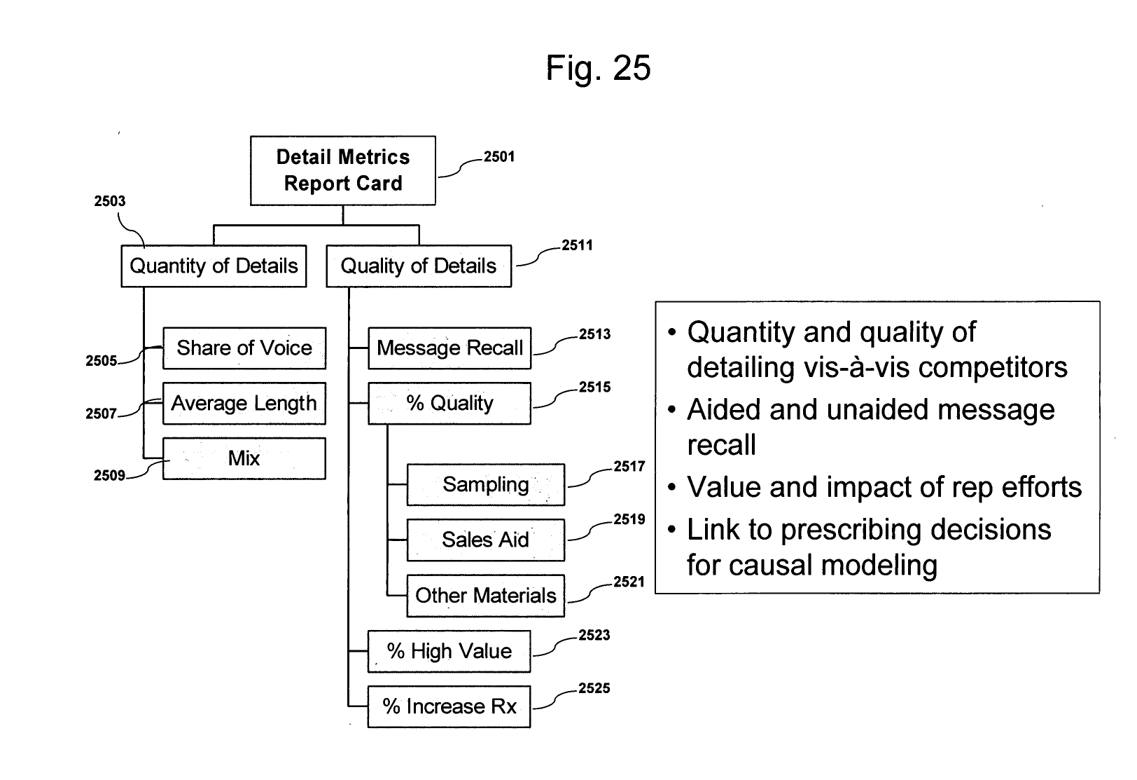

FIG. 25 illustrates the sales representative promotion and detail metrics area. “Detail Metrics Report Card” 2501 focuses generally on quantity metrics 2503 and quality metrics 2511. Quantity metrics contain three components: 1) share of voice 2505; 2) detail length 2507; and 3) detail mix 2509. Quality metrics contain 1) message recall 2513; 2) “quality” details, 2515 which are defined based on the sampling 2517, sales aid 2519 and other material usage 2521; 3) percent high value 2523; and 4) intent to increase prescriptions 2525.

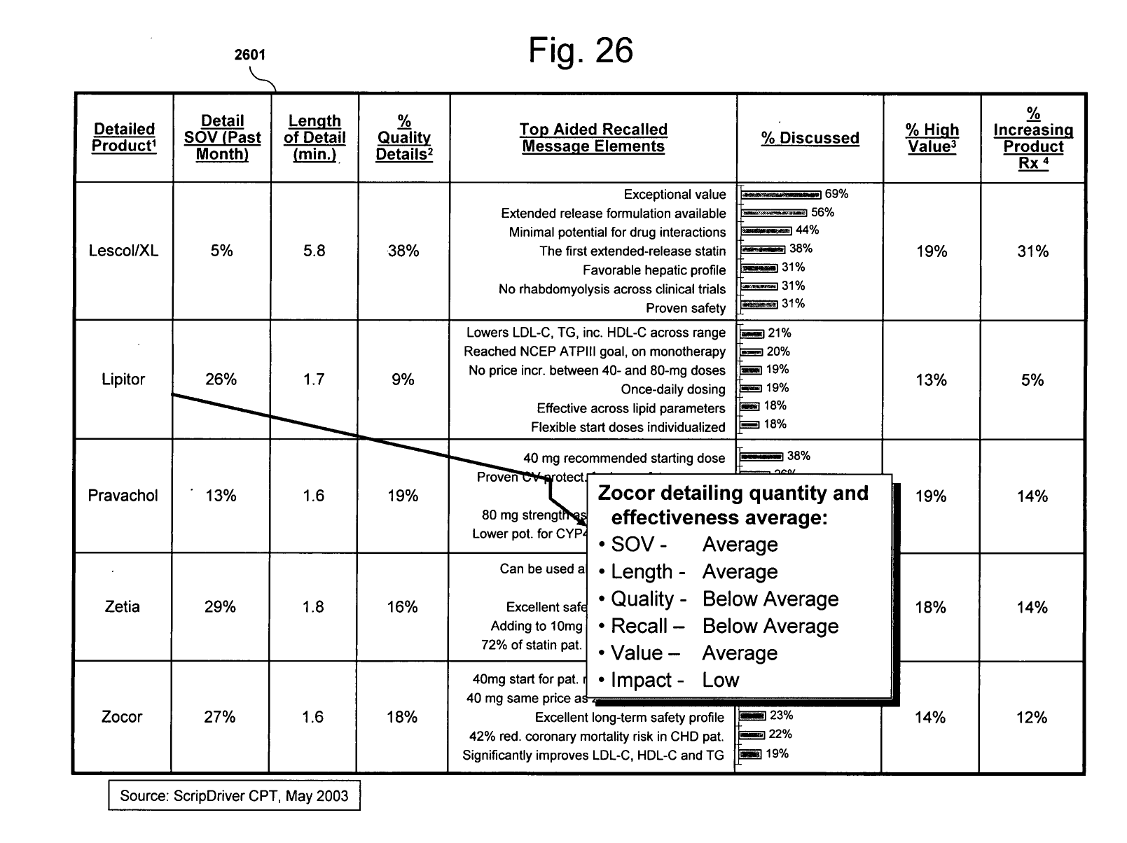

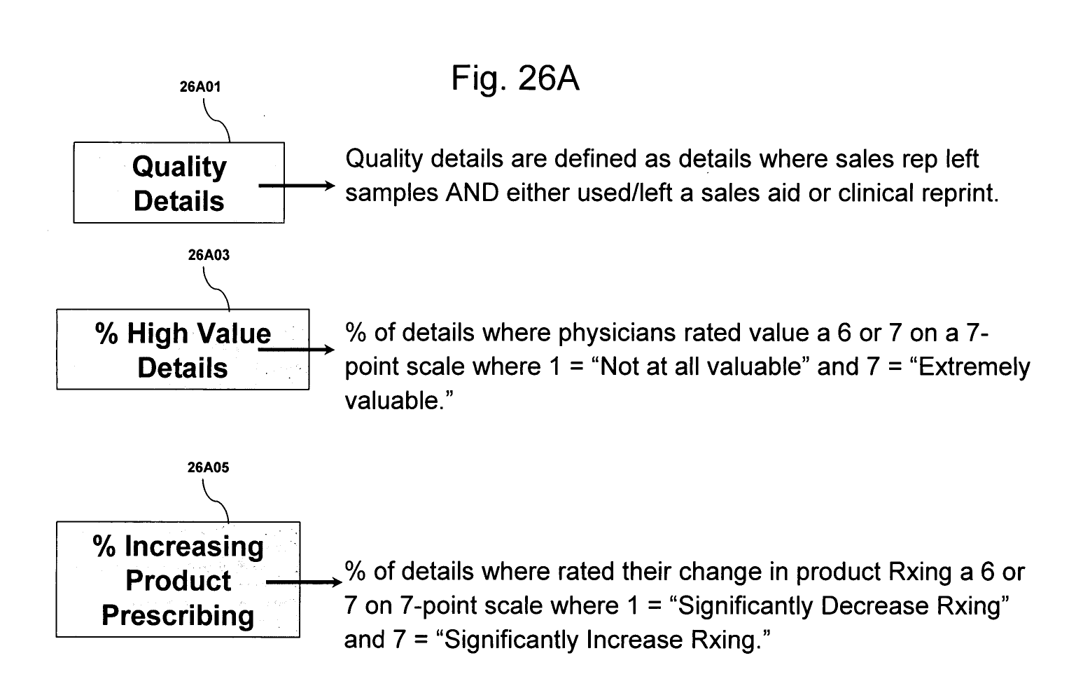

FIG. 26 further exemplifies a Detail Metrics Report Card 2601, which examines across the competitive set several different measures, such as share of voice (“SOV”) and detail length, as quantity measures. Quality measures include quality details, message recall, value and impact. This report card 2601 is formatted as a one-page overview of the market promotions for the month. For example, the report card 2601 indicates that 69% of physicians recall the sales message that Lescol/XL was of exceptional value. “Exceptional value” was also the top aided recalled message for Lescol/XL, and 31% of physicians indicated they would increase prescription writing for Lescol/XL.

FIG. 26A elaborates on and explains some of the factors used to create the detailed report card. “Quality Details” 26A01 are defined as details where the sales representative provided the physician with samples and either used or left a sales aid or clinical report. “Percent High Value Details” 26A03 indicates the percent of details physicians rated a 6 or 7 on a 1-7 scale, where 1=“not at all valuable” and 7=“extremely valuable.” “Percent Increasing Product Prescribing” 26A05 represents the percent of details where physicians rated a 6 or 7 for their change in product prescribing, where 1=“significantly decrease prescribing” and 7=“significantly increase prescribing.”

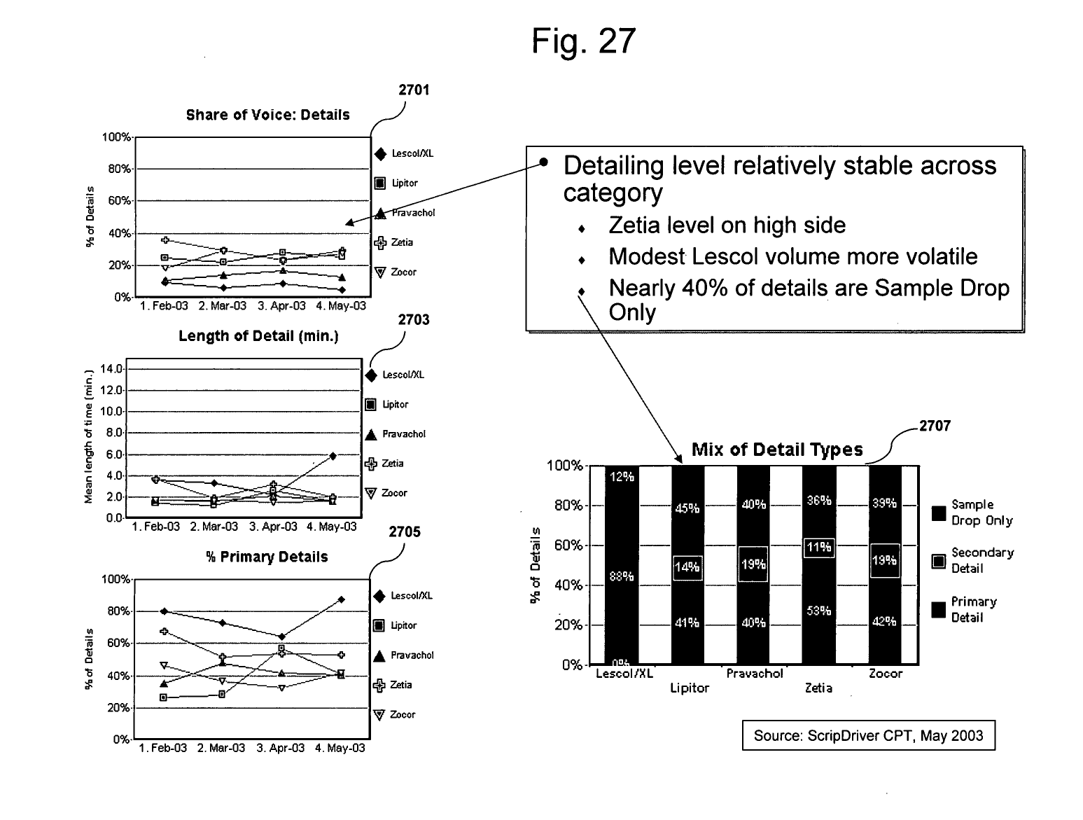

FIG. 27 shows a more detailed view from the CPT area. All measures from the report card are trended over time in 2701, 2703 and 2705, and highlight any significant trends or patterns in the promotional data over time. Companies may then evaluate the effect of any changes in promotional strategies on the perceived impact or value of their promotion in the market. Lescol/XL, for example, underwent a significant increase in both length of detailing and percent of primary details between April and May of 2003. Overview of the detail mix 2707 is another quantity metrics to be examined that is not recorded within the report card. This report displays the details collected from physicians, in particular what percent of them are primary details, secondary details and sample drops only, for each specific product. For example, physicians report that 88% of details for Lescol/XL were “primary.”

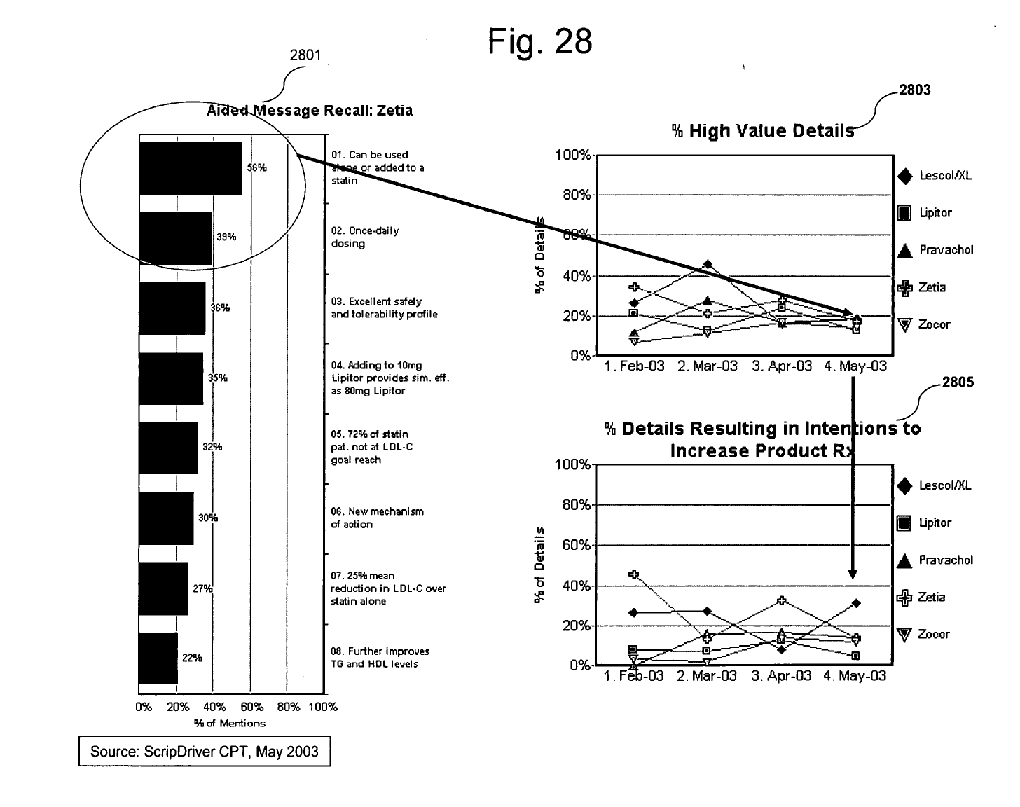

FIG. 28 illustrates message depth and views from the detailed metrics section. Aided Message Recall 2801 is from the promotional study. Aided Message Recall 2801 is collected specific to each product and enables companies to examine aided messages. These messages are collected from a detail aid mail review service establishing a separate panel of physicians that mail in sales aids left behind by sales representatives each month. The system's database stores and maintains specific unique aided messages for over 500 promoted products in the country. Value and increase impact are trended over time at 2803 and 2805, and integrated with aided message recall at 2801.

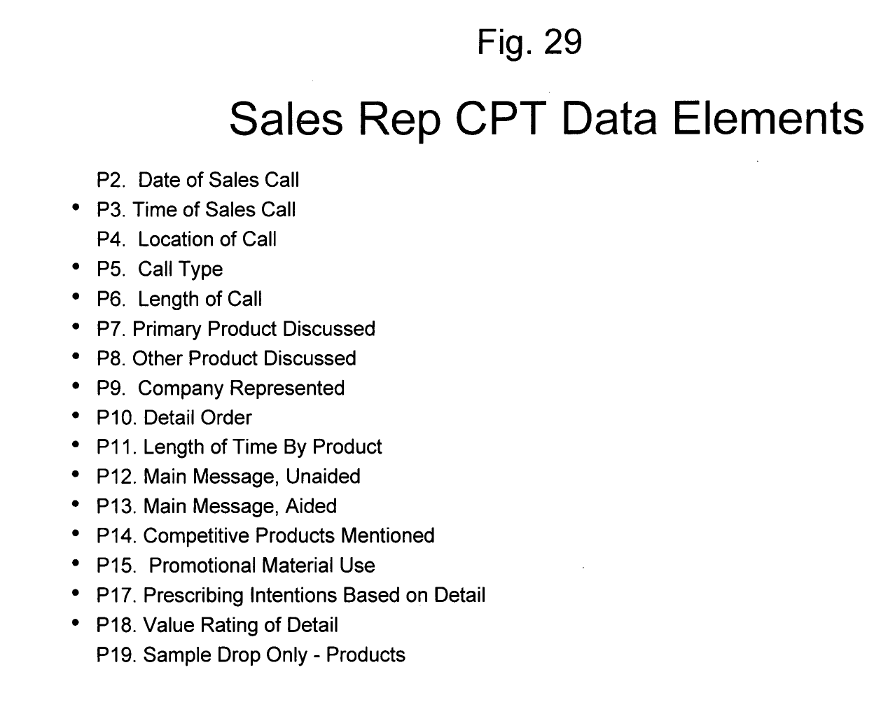

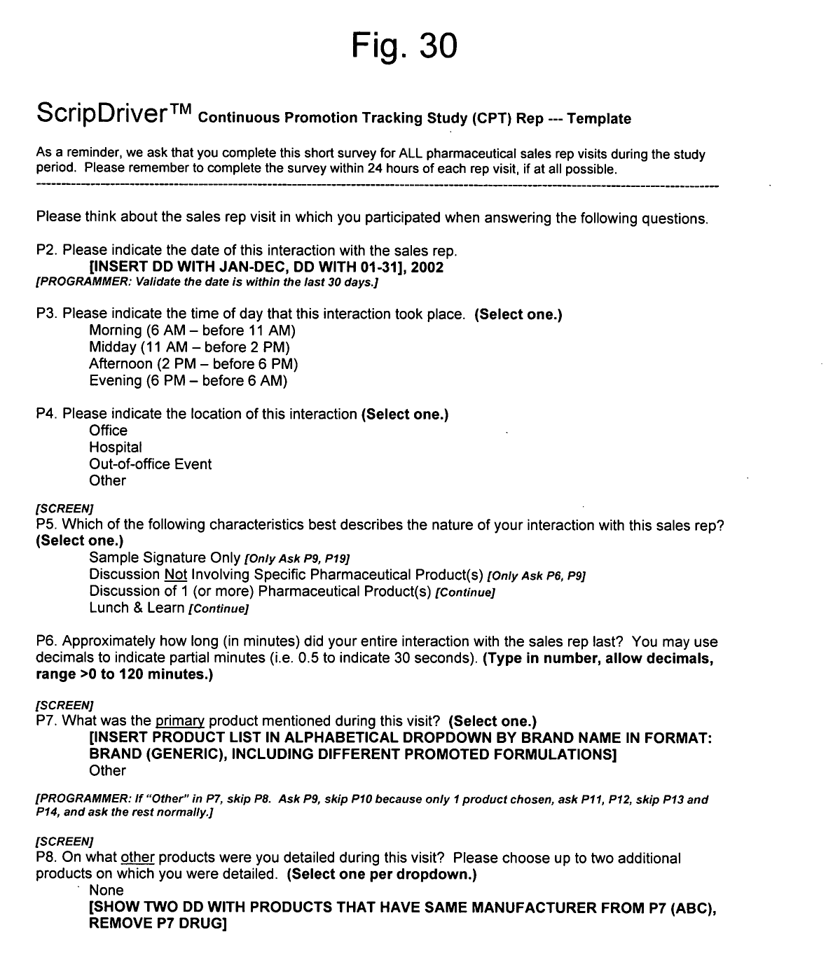

FIGS. 29 through 34 contain data elements (i.e., survey topics) and portions of templates from all three of the surveys (CPT, RxIT and TCAP) that facilitate the on-line questions for the various drugs. The templates are usable for multiple items in the questions asked of the physician panelists. FIGS. 29 and 30 contain data elements and an exemplary portion of the template for the CPT survey, which include the date, time and length of the pharmaceutical representative sales call, as well as what occurred during those meetings. For example, the topic “Date of Sales Call,” at P2 in FIG. 29, is addressed by question “Please indicate the date of this interaction with the sales rep,” which is shown at P2 in FIG. 30. As previously discussed, physicians will complete this survey each time they have an encounter with a sales representative.

FIGS. 31 and 32 contain data elements and an exemplary portion of the template for the RxIT survey, which include the patient's diagnosis and insurance information, as well as reasons for prescribing and/or switching from/to a particular brand, if applicable. For example, the topic “Primary Diagnosis” at R5 in FIG. 31 is addressed by the question “What is this patient's primary diagnosis?” shown at R5 in FIG. 32. The physician is asked to choose among a list of diagnoses.

Certain questions are compiled based on previous answers within that survey. Continuing with this example, the survey asks, with respect to the patient's condition specified by the physician in R5, “For how long (in years) has this patient been diagnosed with this [CONDITION]?” R6 Subsequent questions are asked via the template, based on the physician's specification of the patient's condition.

FIGS. 33 and 34 data elements and an exemplary portion of the template for the TCAP survey, which include patient volume treated by patient type, familiarity/knowledge of products and reasons products may be considered “less appropriate.” For example, the topic “Unaided Awareness of New and In-Development Products,” at T5 in FIG. 33 is addressed by the question: “What [CATEGORY] drugs, line extensions or formulations are you aware of that are expected to launch (within the next three months) or were newly launched (within the last six months) or were newly approved to treat [CONDITION] (within the last six months)?,” at T5 in FIG. 34.

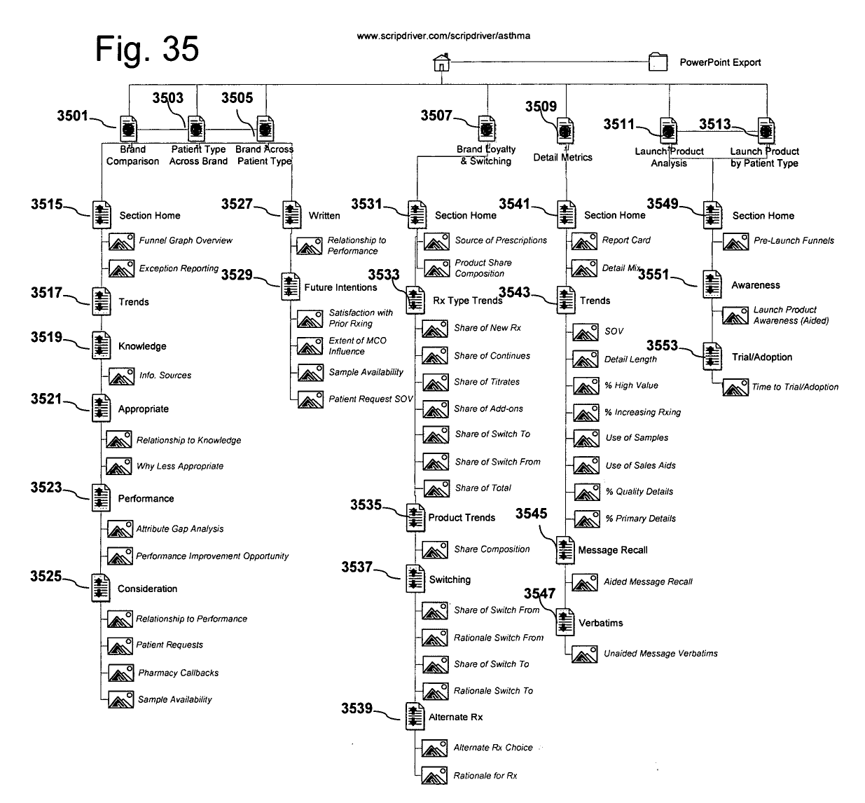

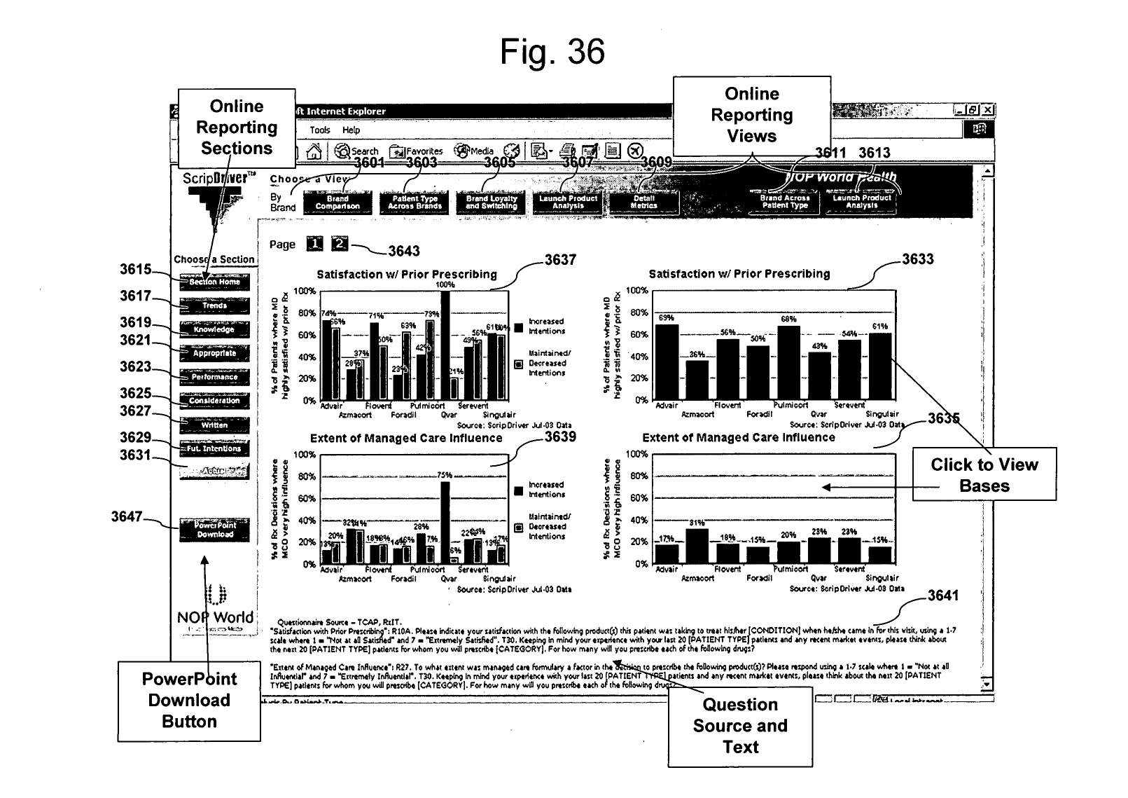

FIG. 35 represents an outline of the structure and scope of the on-line system that subscribing companies access to view their monthly reports. FIG. 35 may be read in conjunction with FIG. 36, which is an example of an on-line report. The top lines of boxes on both FIGS. 3501-3513 and 3601-3613 represent the different views available for reviewing reports. Views are selected by pointing the mouse arrow at one of the top boxes and left-clicking. Blue boxes represent those views which are not selected, while the box describing the current view is purple-colored. The top, left-most box represents the “Brand Comparison” view 3501, 3601, which provides a comparison of the core brands covered in the survey instruments on both Brand Equity and Decision Dynamic metrics (as defined in FIG. 8) through the Rx Decision Funnel (see FIG. 8) and linked drill-downs (see FIG. 9). “Patent Type Across Brand” 3503, 3603 provides a subset of the analyses provided within the Brand Comparison view for one chosen patient type. In this view, the user selects a report for a particular patient type by selecting from a dropdown menu on the screen. “Brand Loyalty and Switching” 3505, 3605 provides a view of loyalty metrics and switching dynamics between the core brands, as discussed more fully in FIGS. 20, 21 and 23. “Launch Product Analysis (By Brand)” 3507, 3607 (when applicable to the therapeutic class) provides a view of the expected Rx Decision Funnel for the launch brand, versus the inline product once the product becomes available (see FIGS. 9 and 19). “Detail Metrics” 3509, 3609 provides a report card display overview of promotional detailing activities for each of the core brands included in the applicable therapeutic class, including Share of Voice (“SOV”) metrics and message recall (see FIGS. 25-28). Reports in this view are based on answers to the CPT survey questions (FIGS. 29-30). “Brand Across Patient Type” 3511, 3611 provides a comparison of a chosen brand's performance for each of the patient types covered in the survey instruments, using similar metrics as the Brand Comparison section, including an Rx Decision funnel for that brand for each patient type. “Launch Product Analysis (By Patient Type)” 3513, 3613 (when applicable to the therapeutic class) provides a view of the expected Rx Decision Funnel for the launch brand versus the inline product once the product becomes available, comparing each of the patient types covered in the survey instruments (see FIGS. 9 and 19).

The remaining boxes in FIG. 35 (3515-3553), represent a comprehensive list of the different sections within each view that are currently available. Depending on which view is chosen, different sections will be available for viewing. The first section available for viewing within the Brand Comparison view on FIG. 36 is the “Section Home” 3615, an initial starting point for each view that enables companies to understand potential issue areas for their brand, versus those for a competitive set. The Section Home also provides visibility to areas of improvement and/or opportunity areas for the brand. Companies may then examine the following major sections for specific drill downs pertaining to each category: Trends 3617, Knowledge 3619, Appropriateness 3621, Performance 3623, Consideration 3625, Written 3627 and Future Intentions 3629. The substantive nature of these categories was discussed in the description of FIG. 8, and the questions exploring these categories are listed at FIGS. 29-34. Within certain views, certain sections may not be applicable, and therefore are not available for viewing. Those sections are represented by gray boxes. For example, a user who enters the “Patient Type Across Brands” view will notice that the Knowledge and Performance sections are gray, and are thus unavailable for viewing. Also, on FIG. 35, many of the sections contain one or more reports (most of which are drilldown reports, discussed at FIG. 9) appearing on the same webpage screen. FIG. 36 also shows selected drill down reports and cross-sectional analyses 3633-3639, which would appear in the Future Intentions section of the Brand Comparison view. This particular section/view combination view is also represented on the on-line reporting outline 3529. In this particular screen, the following drill downs are reported: Satisfaction with Prior Rxing, Extent of MCO Influence, Sample Availability and Patient Request SOV. At the bottom of each screen, the questionnaire sources underlying the report are identified (CPT, RxIT or TCAP) 3641, as well as the particular question(s), examples of which may be found in the partial survey templates discussed at FIGS. 29-34. Because the volume of reporting within a particular section/view combination may not fit feasibly on one screen, multiple pages may be used. To access a particular page within the section/view combination, the user will place the mouse arrow over the page the user wishes to view 3643, and will left-click to load that page. Unselected pages are represented by blue boxes, while selected pages are represented by purple boxes. Additionally, for all reports, the user may select and left-click on any report, and the “bases/n's” (i.e., the number of respondents for that particular report) will be displayed.

On any screen, the user may also select the “PowerPoint Download” button 3647, which will enable the user to download every page on all of the possible section/view combinations, in PowerPoint format. The user will then have the option of viewing the report locally, copying reports saved as GIF images and printing exemplary reports concerning the company's brand(s) in hard copy. An Excel-based deliverable is also available, and contains the chart data for each analysis contained within the on-line deliverable. Each array of chart data is on a separate worksheet, and workbooks are organized based on the online reporting views. The worksheet contains both the chart data and the GIF chart pasted in from the online reporting.

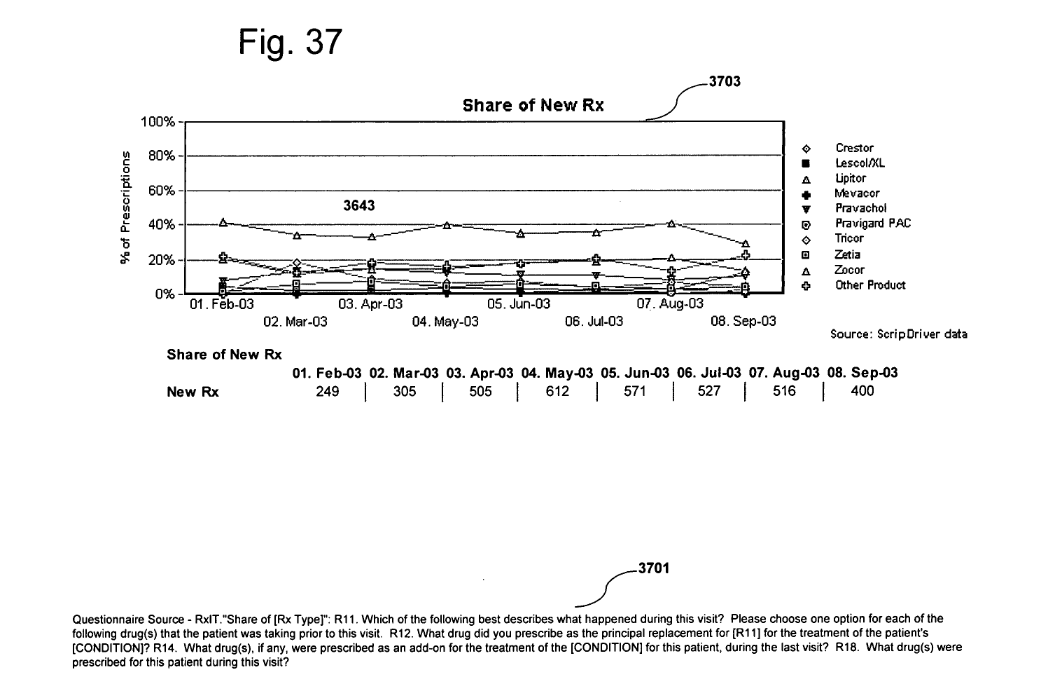

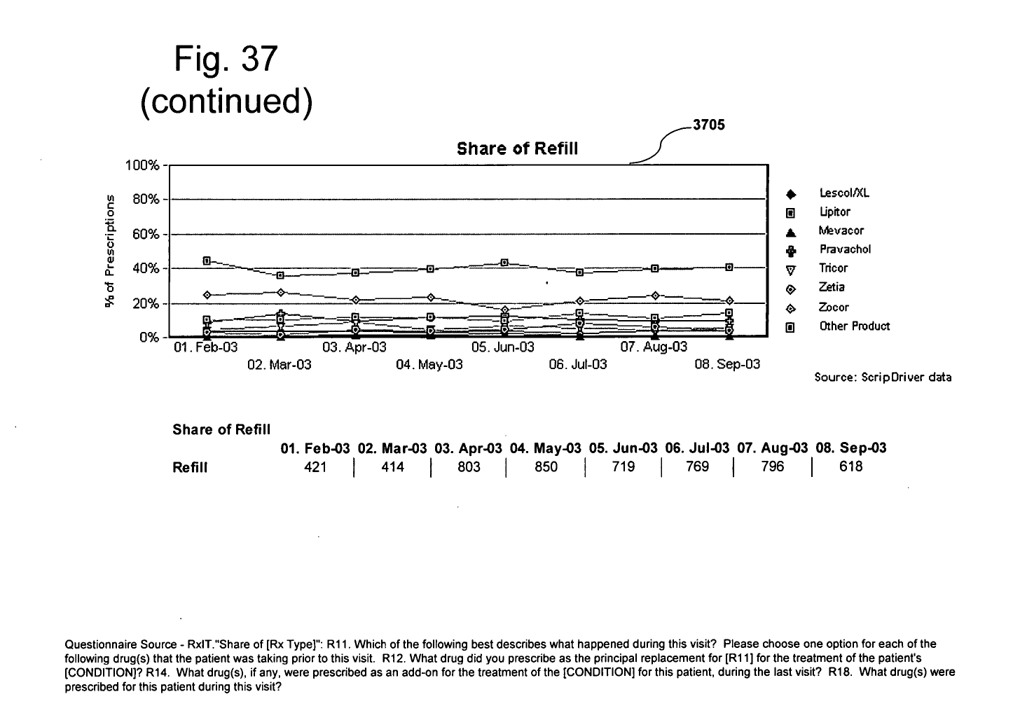

As another example, the outline of the on-line reporting structure indicates that the Rx Type Trends section within the Brand Loyalty and Switching view 3533 contains seven different reports, illustrating trends based on questions from the RxIT survey. For example, as shown in FIG. 37 panel physicians were asked what occurred during a particular patient visit in terms of prescribing medications R11, 3701. Report 3703 shows Trends across multiple data collection periods pertaining to what percent of new prescriptions were written for a particular brand. The amount of new prescriptions for Lipitor remained relatively consistent from February of 2003 to September of 2003, ranging from approximately 35-40%. Lipitor was the brand for which the highest percentage of new prescriptions were written. Another report on page 2 of the same section/view combination 3705, indicates that Lipitor also held the highest percentage of share of refills, and that this percentage remained relatively consistent over time.

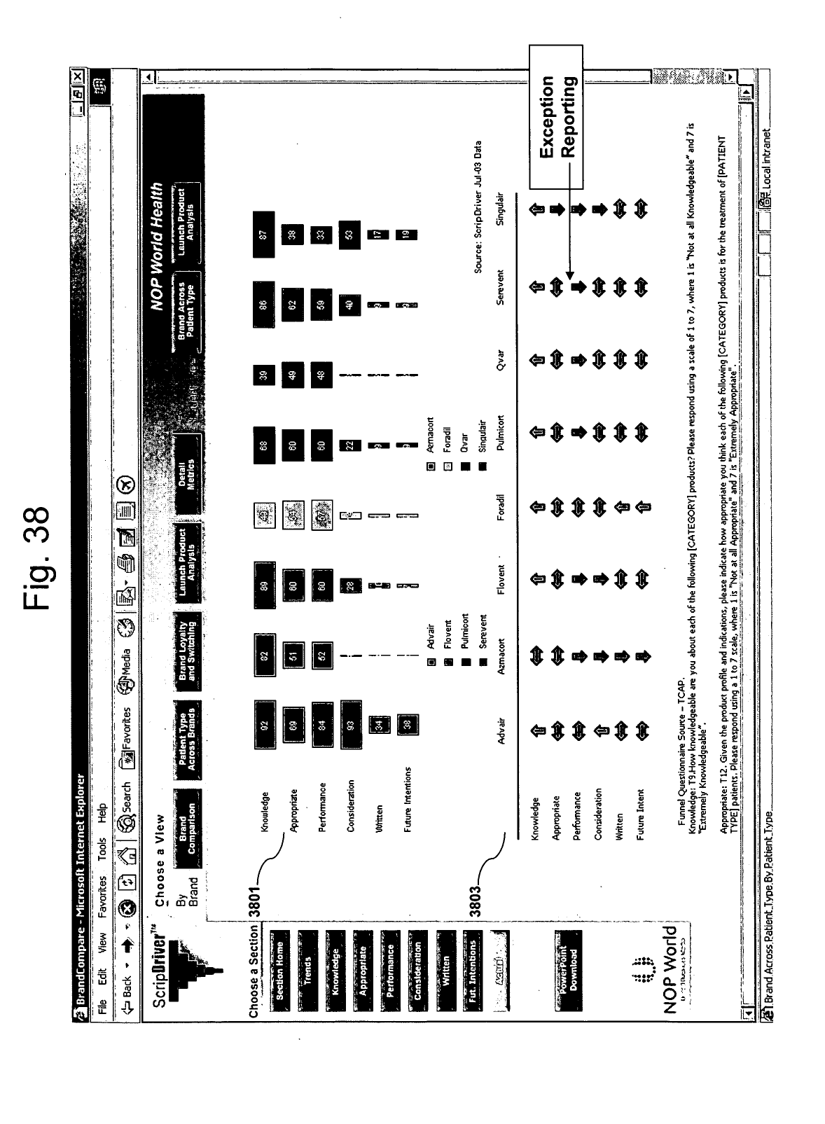

FIG. 38 exemplifies the Section Home/Brand Comparison section/view combination, which contains a report displaying a competitive set of brand funnels 3801, as well as Exception Reporting 3803, highlighting significant changes in ratings for each of the six categories, occurring between data collection periods. Arrows facing upward indicate significant increases, downward arrows indicate significant decreases and arrows pointed toward the right and left indicate that no significant changes occurred between data collection periods for that particular brand funnel category.

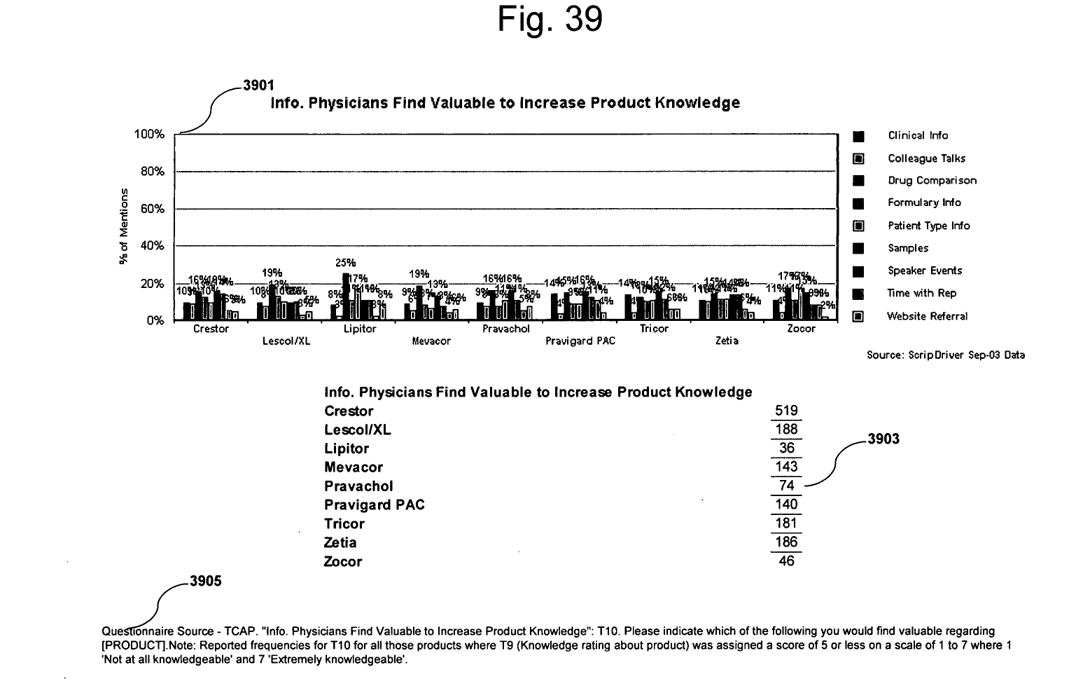

FIGS. 39-44 show additional reports (primarily analyzing drill downs for various categories) exemplifying the types of analyses that the system is capable of producing. FIG. 39 contains a report 3901 showing “Information Physicians Find Valuable to Increase Product Knowledge,” which is one of the drill downs for Knowledge (discussed at FIG. 9 901). The base “n” 3903 is also visible on the screen, and indicates the amount of respondents whose answers to the TCAP survey (FIGS. 33-34 T9, T10) were used in that particular report. The only answers considered were by those respondents who did not assign a high (6-7) rating for Knowledge (because the answers of those respondents already having a high level of knowledge would not be of interest to improving a company's product knowledge) 3905. For example, of the 519 physicians who assigned a value of 5 or less for Knowledge with respect to Crestor, 10% would find clinical information helpful, and 16% would find drug comparisons helpful.

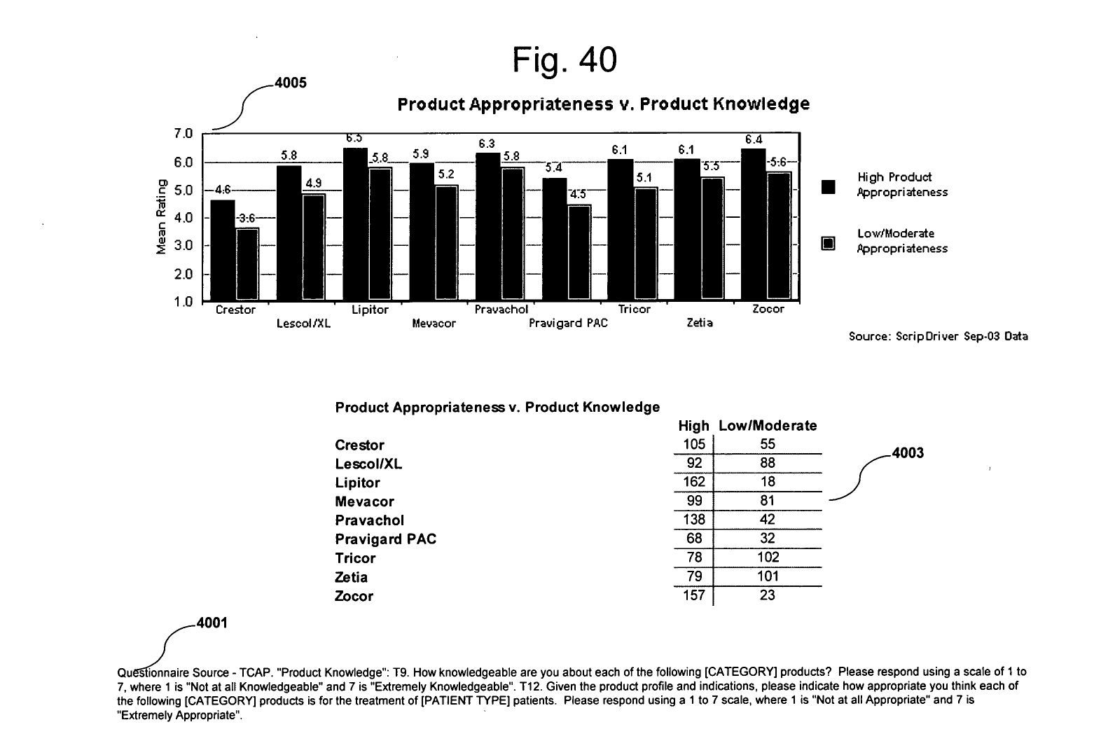

FIG. 40 shows a cross-sectional analysis report, examining the relationship between Product Knowledge and Product Appropriateness. As discussed in FIG. 9 905, Appropriateness may be correlated with Knowledge, and Correlation with Knowledge is thus a drill down for Appropriateness. This exemplary report is derived from the TCAP survey (FIG. 33-34, T9 and T12), which asks the panel physicians to rate the product from a 1 to 7 in Knowledge and Appropriateness 4001. Responses of physicians assigning a high value (6-7) of Appropriateness are separated from those assigning a moderate to low value (<6) 4003, and two cohorts are created from those responses. In report 4005, the user may examine the mean value assigned to Knowledge for each of the two cohorts. For each one of the brands listed, the mean rating for Knowledge was higher in the cohort assigning a high value to Appropriateness than in the cohort assigning a moderate to low value. For example, with respect to Crestor, the mean value for Knowledge was higher (4.6) among those physicians assigning a value of 6-7 to Appropriateness than among those physicians assigning a value of less than 6 for Appropriateness (3.6). If Appropriateness is an issue for a company's brand based on the its assessment of the Rx Decision Funnel, this report 4005 enables the company to understand the degree to which brand familiarity influences the Appropriateness perceptions. Where a “High Appropriateness” group reports higher familiarity with the brand than the “Low Appropriateness” group as to a company's brand, that company might consider table marketing and/or sales actions to raise brand knowledge (as more knowledgeable physicians tend to find the product more appropriate).

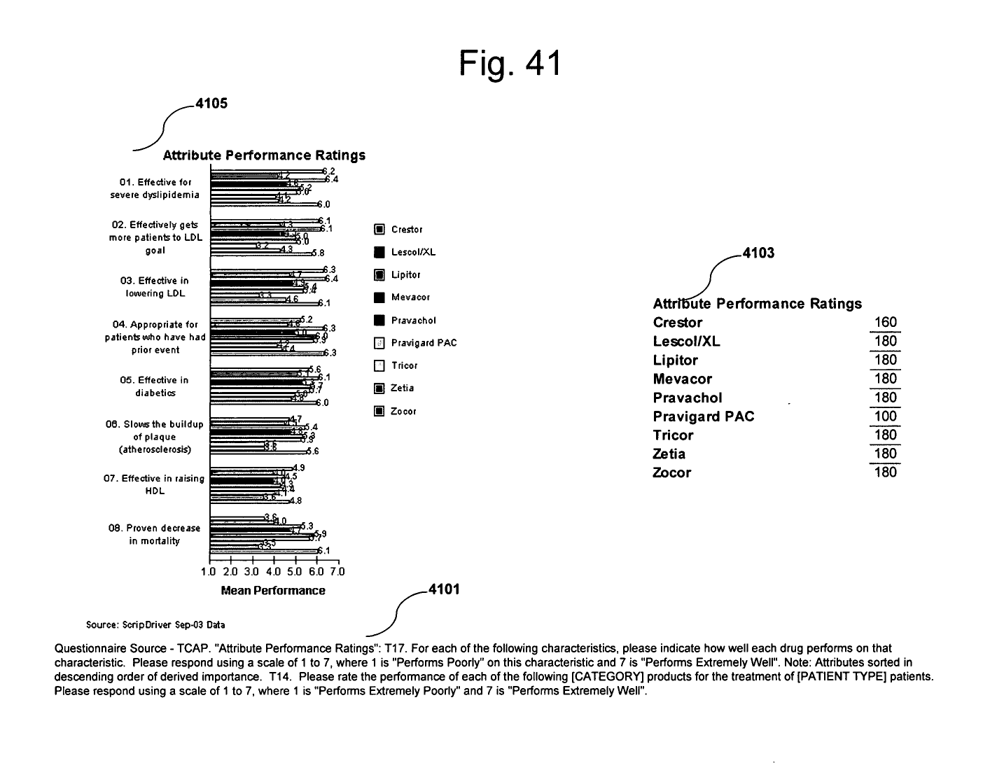

FIG. 41 shows a report similar to the report in FIG. 16, and analyzes Key Attribute Gaps. While FIG. 16 shows the deviations from the average mean performance attribute ratings for each brand, FIG. 41 examines the same attributes, but displays the actual mean value (1-7) for each brand in a competitive set. For example, based on the TCAP survey questions T14 and T17 asking the physician to assign a value for Performance attributes 4101, the 180 physicians who responded with respect to Lescol/XL 4103 assigned a mean value of 4 for “Proven decrease in mortality” 4105.

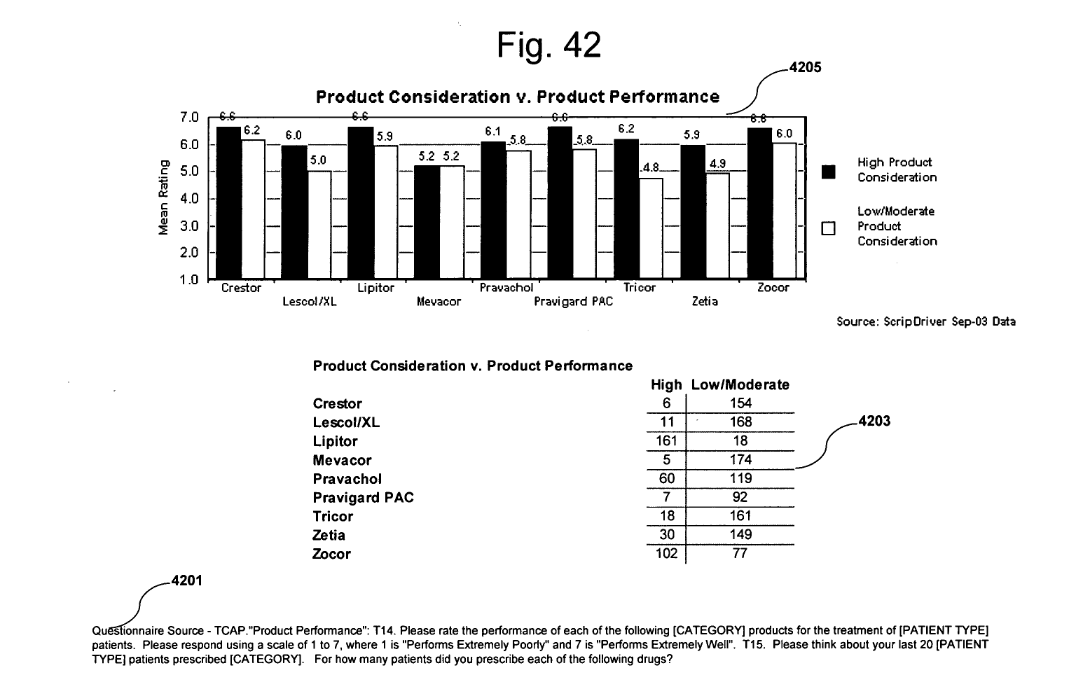

FIG. 42 shows another cross-sectional analysis between Consideration and Performance. Those physicians who assigned a high value for Consideration (meaning, the brand was prescribed for 4+out of the physician's last 20 patients) based on the TCAP survey question T15 were separated into two cohorts 4203, and a report 4205 was generated showing how each brand fared between the two cohorts for product performance. For example, of the 161 physicians who gave “High Consideration” for Lipitor, the mean Performance rating was 6.6, while the mean Performance rating was a lower 5.8 for those who gave “Moderate to Low Consideration” for Lipitor. If Consideration is an issue for a company's brand based on its assessment of the Rx Decision Funnel, the report would enable that company to understand the extent to which the brand's Performance relates to the its level of Consideration in prescribing decisions. If the “High Product Consideration” cohort of physicians reports higher product performance perceptions than the “Low/Moderate Consideration,” the company might consider focusing on improving perceptions of product Performance (perhaps by reviewing the drill downs for Performance, discussed at FIG. 9) with the goal of improving the brand's Consideration.

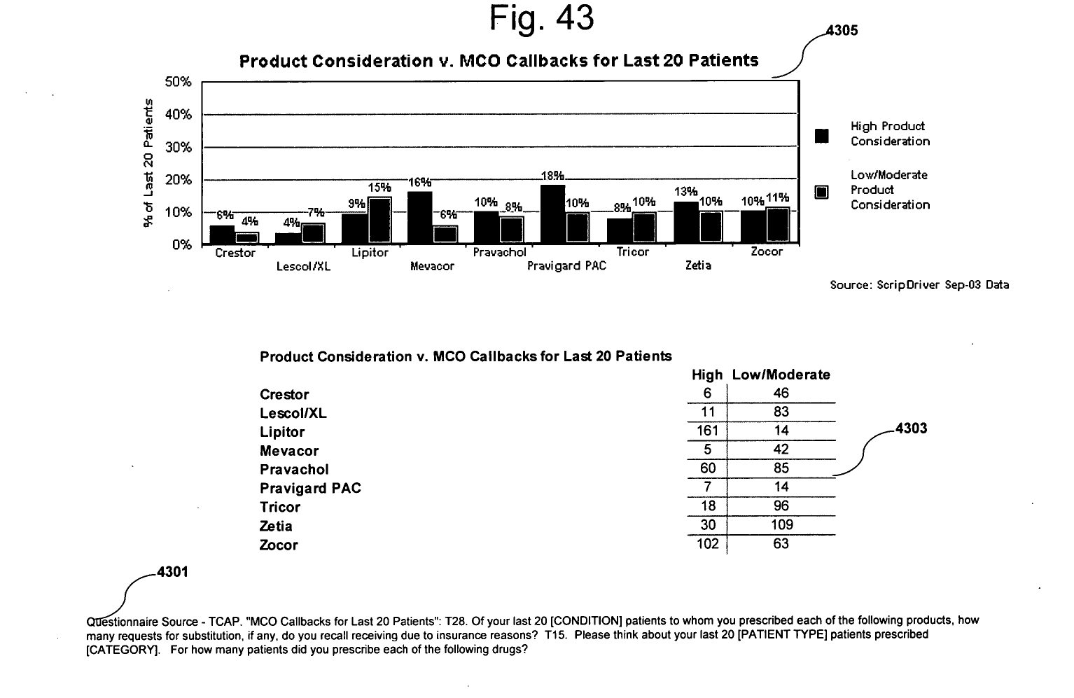

FIG. 43 shows a drill down analysis report pertaining to the Consideration Brand Funnel Category. As discussed in FIG. 9 915, MCO Callbacks is a drill down (i.e., a factor potentially affecting a brand's rating) for Consideration. In the TCAP survey, panel physicians are asked for how many of their last 20 patients, they: 1) prescribed a particular brand FIG. 33-34 T28; and 2) received a request for substitution due to insurance-related reasons (FIG. 33-34 T15) 4301. Depending on the Consideration rating (“High” versus “Low/Moderate”) in T28, physicians are separated into two cohorts 4303, and the responses of the two cohorts are compared in report 4305. For example, of the 102 physicians giving High Consideration to Zocor, 10% on average of their last 20 patients requested a substitute for MCO-related reasons, while those giving Moderate/Low Consideration received more (11%) MCO Callbacks (a small correlation). This report may enable companies to determine the extent to which MCO Callbacks impact a physician's Consideration of their brand(s).

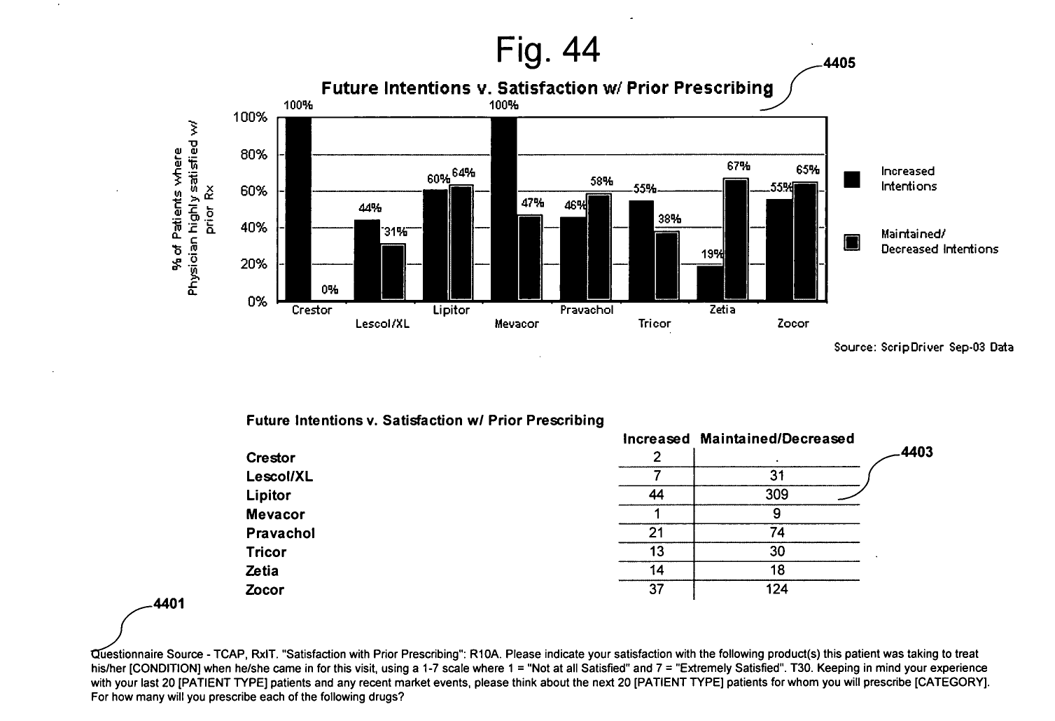

FIG. 44 is a drill down analysis report showing a cross-sectional analysis of “Satisfaction with Prior Prescribing (see FIG. 9 927) with Future Intentions. Similar to the other cross-sectional analyses, this report is generated based on responses to survey questions 4401, which are separated into two cohorts 4403 based on the responses to the questions. The results for each cohort are displayed 4405 in a manner enabling a subscribing company to examine the extent to which Satisfaction with Prior Prescribing affects the physician's Future Intentions to prescribe the drug.

Although the invention has been shown and described with respect to a best mode embodiment thereof, it should be understood by those skilled in the art that carious changes, omissions, and additions may be made to the form and detail of the disclosed embodiment without departing from the spirit and scope of the invention, as recited in the following claims.

1. A method for assessing the effect of sales representative activity on pharmaceutical prescriptions comprising:
a. collecting sales representative activity data from a plurality of physicians who prescribe at least one pharmaceutical of interest;
b. collecting pharmaceutical prescription data of said plurality of physicians regarding said at least one pharmaceutical of interest; and
c. analyzing said sales representative activity data and said pharmaceutical prescription data to assess a correlation therebetween.

2. The method of claim 1 wherein said pharmaceutical prescription data is collected via the Internet.

3. The method of claim 1 wherein said sales representative activity data is collected via the Internet.

4. The method of claim 1 further comprising:
a. collecting physician pharmaceutical attitudinal data from said plurality of physicians regarding said at least one pharmaceutical of interest.

5. The method of claim 4 wherein said physician pharmaceutical attitudinal data is collected via the Internet.

6. The method of claim 4 further comprising:
a. analyzing said sales representative activity data, said physician pharmaceutical attitudinal data and said pharmaceutical prescription data to assess a correlation therebetween.

7. The method of claim 6 wherein said analysis of said physician pharmaceutical attitudinal data and said pharmaceutical prescription data includes a hierarchical organization thereof.

8. The method of claim 7 wherein said hierarchical organization is provided in graphical form.

9. The method of claim 7 wherein said hierarchical organization has the order of knowledge data, appropriateness data, performance data, consideration data, written data, and future intentions data.

10. The method of claim 9 wherein said knowledge data, said appropriateness data, said performance data and said consideration data are derived from said physician pharmaceutical attitudinal data and said written data and said future intentions data are derived from said pharmaceutical prescription data.

11. A system for assessing the effect of sales representative activity on pharmaceutical prescriptions comprising:
a. a database for sales representative activity data, said sales representative activity data collected from a plurality of physicians who prescribe at least one pharmaceutical of interest;
b. a database for pharmaceutical prescription data collected from said plurality of physicians regarding said at least one pharmaceutical of interest; and
c. a processor for analyzing said sales representative activity data and said pharmaceutical prescription data to assess a correlation therebetween.

12. The system of claim 11 wherein said pharmaceutical prescription data is collected via the Internet.

13. The method of claim 1 wherein said sales representative activity data is collected via the Internet.

14. The system of claim 11 further comprising:
a. a database for physician pharmaceutical attitudinal data, said physician pharmaceutical attitudinal data collected from said plurality of physicians regarding said at least one pharmaceutical of interest.

15. The system of claim 14 wherein said physician pharmaceutical attitudinal data is collected via the Internet.

16. The system of claim 14 wherein said processor analyzes said sales representative activity data, said physician pharmaceutical attitudinal data and said pharmaceutical prescription data to assess a correlation therebetween.

17. The system of claim 16 wherein said analysis of said physician pharmaceutical attitudinal data and said pharmaceutical prescription data includes a hierarchical organization thereof.

18. The system of claim 17 wherein said hierarchical organization is provided in graphical form.

19. The system of claim 17 wherein said hierarchical organization has the order of knowledge data, appropriateness data, performance data, consideration data, written data, and future intentions data.

20. The system of claim 19 wherein said knowledge data, said appropriateness data, said performance data and said consideration data are derived from said physician pharmaceutical attitudinal data and said written data and said future intentions data are derived from said pharmaceutical prescription data.

21. A system for assessing the effect of sales representative activity on pharmaceutical prescriptions comprising:
a. a database for sales representative activity data, said sales representative activity data collected from a plurality of physicians who prescribe at least one pharmaceutical of interest;
b. a database for physician pharmaceutical attitudinal data, said physician pharmaceutical attitudinal data collected from said plurality of physicians;
c. a database for pharmaceutical prescription data collected from said plurality of physicians regarding said at least one pharmaceutical of interest; and
d. a processor for analyzing said sales representative activity data, said physician pharmaceutical attitudinal data, said pharmaceutical prescription data to assess a correlation therebetween.

22. The system of claim 21 wherein said physician pharmaceutical attitudinal data is collected via the Internet.

23. The system of claim 21 wherein said pharmaceutical prescription data is collected via the Internet.

24. The system of claim 21 wherein said sales representative activity data is collected via the Internet.

25. The system of claim 21 wherein said analysis of said physician pharmaceutical attitudinal data and said pharmaceutical prescription data includes a hierarchical organization thereof.

26. The system of claim 25 wherein said hierarchical organization is provided in graphical form.

27. The system of claim 25 wherein said hierarchical organization has the order of knowledge data, appropriateness data, performance data, consideration data, written data, and future intentions data.

28. The system of claim 27 wherein said knowledge data, said appropriateness data, said performance data and said consideration data are derived from said physician pharmaceutical attitudinal data and said written data and said future intentions data are derived from said pharmaceutical prescription data.

29. A method for assessing the effect of sales representative activity and physician pharmaceutical attitude on pharmaceutical prescriptions comprising:
a. collecting sales representative activity data from a plurality of physicians who prescribe at least one pharmaceutical of interest;
b. collecting physician pharmaceutical attitudinal data from said plurality of physicians;
c. collecting pharmaceutical prescription data of said plurality of physicians regarding said at least one pharmaceutical of interest; and
d. analyzing said sales representative activity data, said physician pharmaceutical attitudinal data, and said pharmaceutical prescription data to assess a correlation therebetween.

30. The method of claim 29 wherein said physician pharmaceutical attitudinal data is collected via the Internet.

31. The method of claim 29 wherein said pharmaceutical prescription data is collected via the Internet.

32. The method of claim 29 wherein said sales representative activity data is collected via the Internet.

33. The method of claim 29 wherein said analysis of said physician pharmaceutical attitudinal data and said pharmaceutical prescription data includes a hierarchical organization thereof.

34. The method of claim 33 wherein said hierarchical organization is provided in graphical form.

35. The method of claim 33 wherein said hierarchical organization has the order of knowledge data, appropriateness data, performance data, consideration data, written data, and future intentions data.

36. The method of claim 35 wherein said knowledge data, said appropriateness data, said performance data and said consideration data are derived from said physician pharmaceutical attitudinal data and said written data and said future intentions data are derived from said pharmaceutical prescription data.
